(19) United States
(12) Patent Application Publication
(10) Pub. No.: US 2014/0149118 A1
(43) Pub. Date: May 29, 2014

(54) APPARATUS AND METHOD FOR DRIVING ELECTRIC DEVICE USING SPEECH RECOGNITION

(71) Applicant: LG ELECTRONICS INC., Seoul (KR)

(72) Inventors: Heungkyu LEE, Seoul (KR); Lagyoung KIM, Seoul (KR); Jaewoong JEONG, Seoul (KR)

(73) Assignee: LG ELECTRONICS INC.

(21) Appl. No.: 14/029,626

(22) Filed: Sep. 17, 2013

Related U.S. Application Data
(63) Continuation-in-part of application No. PCT/KR2012/010156, filed on Nov. 28, 2012.

(30) Foreign Application Priority Data
Jun. 18, 2013 (KR) 10-2013-0069658

(51) Int. Cl. G10L 21/06

(52) U.S. Cl. CPC G10L 21/06
USPC 704/251

(57) ABSTRACT

An apparatus and method for driving an electric device using speech recognition are disclosed. The method for driving an electric device using speech recognition includes switching an operation stop state to a pre-operation speech recognition standby mode if a first keyword is recognized at the operation stop state; starting basic operation of the device if a second keyword is recognized at the pre-operation speech recognition standby mode; and performing a corresponding command if at least one of a plurality of command languages that may be recognized by a user command is recognized within a predefined time during the basic operation, wherein the first keyword, the second keyword and the plurality of command languages are different from one another.

### CROSS REFERENCE TO RELATED APPLICATIONS

This application is a Continuation-In-Part of International Application No. PCT/KR2012/010156, filed on Nov. 28, 2012, and claims the benefit of earlier filing date and right of priority to Korean Patent Application No. KR 10-2013-0069658, filed on Jun. 18, 2013, the contents of which are all hereby incorporated by reference in their entirety.

### BACKGROUND OF THE INVENTION

1. Field of the Invention

The present invention relates to an electric device, and more particularly, to an apparatus and method for driving an electric device using speech recognition.

2. Discussion of the Related Art

Generally, an electric device receives a control command through a key input unit provided therein and performs a corresponding operation. If the electric device is provided with a remote controller, it may perform the corresponding operation by receiving the control command through a key input unit of the remote controller.

However, such a system that operates the electric device by using the key input unit provided in the remote controller has inconvenience in that the remote controller should always be located near a user. Also, the system that operates the electric device by using the key input unit provided in the electric device or the key input unit provided in the remote controller has inconvenience in that the user should manually manipulate the key input unit provided in the electric device or the key input unit provided in the remote controller. In particular, if the user has lost the remote controller, the user should directly manipulate the key input unit provided in the corresponding electric device.

### SUMMARY OF THE INVENTION

Accordingly, the present invention is directed to an apparatus and method for driving an electric device using speech recognition, which substantially obviates one or more problems due to limitations and disadvantages of the related art.

An object of the present invention is to provide an apparatus and method for driving an electric device using speech recognition, in which the electric device is operated by a speech only of a user through the speech recognition technology without using a side unit such as such as a remote controller or a mobile terminal.

Another object of the present invention is to provide an apparatus and method for driving an electric device using speech recognition, in which the electric device is prevented from being operated in error due to error recognition of a command by using a ‘pre-operation speech recognition standby mode’, ‘speech recognition standby mode during operation’, ‘stop mode’ or ‘standby mode’ when the electric device is operated by a speech of a user.

Additional advantages, objects, and features of the specification will be set forth in part in the description which follows and in part will become apparent to those having ordinary skill in the art upon examination of the following or may be learned from practice of the specification. The objectives and other advantages of the specification may be realized and attained by the structure particularly pointed out in the written description and claims hereof as well as the appended drawings.

To achieve these objects and other advantages and in accordance with the purpose of the specification, as embodied and broadly described herein, a method for driving an electric device using speech recognition comprises the steps of switching an operation stop state to a pre-operation speech recognition standby mode if a first keyword is recognized at the operation stop state; starting basic operation of the device if a second keyword is recognized at the pre-operation speech recognition standby mode; and performing a corresponding command if at least one of a plurality of command languages that may be recognized by a user command is recognized within a predefined time during the basic operation, wherein the first keyword, the second keyword and the plurality of command languages are different from one another.

Also, the method further comprises the step of switching to a speech recognition standby mode during operation if a user command is not recognized within the predefined time during the basic operation or while the user command is being performed, wherein a third keyword should is required to be first recognized to recognize the user command at the speech recognition standby mode during operation.

Also, the third keyword is the same as the first keyword.

Also, the user command includes a fourth keyword for switching to a stop mode.

Also, the method further comprises the steps of switching to a speech recognition standby mode during operation if a user command is not recognized within the predefined time during the basic operation or while the user command is being performed, and switching the speech recognition standby mode during operation to the stop mode if a fourth keyword is recognized at the speech recognition standby mode during operation.

Also, the method further comprises the steps of switching to a speech recognition standby mode during operation if a user command is not recognized within the predefined time during the basic operation or while the user command is being performed, and recognizing either a third keyword or a fourth keyword at the speech recognition standby mode during operation and switching to a state that may recognize another user command if the third keyword is recognized and switching to a stop mode state if the fourth key word is recognized.

Also, the method further comprises the step of recognizing a fifth keyword to switch the stop mode state to the operation stop state.

In other aspect of the present invention, a method for driving an electric device using speech recognition comprising the steps of switching to a speech recognition standby mode if a user command is not recognized within a predefined time during the driving the electric device; switching to an operation mode from the speech recognition standby mode if a predefined keyword is recognized at the speech recognition standby mode; and performing a user command if the user command is recognized during the operation mode, wherein the user command includes one of an operation command and an inquiry command.

In other aspect of the present invention, an apparatus for driving an electric device using speech recognition comprises a speech receiving unit configured to receive a speech; a speech recognition unit configured to recognize a previously set keyword and a user command from the received speech; and a control unit configured to control an operation of the electric device by using the speech recognized result, wherein the control unit controls the operation of the electric device by switching an operation stop state to a pre-operation speech recognition standby mode if a first keyword is recognized at the operation stop state, starting basic operation of the device if a second keyword is recognized at the pre-operation speech recognition standby mode, and performing a corresponding command if at least one of a plurality of command languages that may be recognized by a user command is recognized within a predefined time during the basic operation.

Also, the first keyword, the second keyword and the plurality of command languages are different from one another.

Also, the control unit switches to a speech recognition standby mode during operation if a user command is not recognized within the predefined time during the basic operation or while the user command is being performed, and a third keyword should is required to be first recognized to recognize the user command at the speech recognition standby mode during operation.

Also, the control unit switches to a speech recognition standby mode during operation if a user command is not recognized within the predefined time during the basic operation or while the user command is being performed, and switches the speech recognition standby mode during operation to the stop mode if a fourth keyword is recognized at the speech recognition standby mode during operation.

Also, the control unit switches to a speech recognition standby mode during operation if a user command is not recognized within the predefined time during the basic operation or while the user command is being performed, and recognizes either a third keyword or a fourth keyword at the speech recognition standby mode during operation and switches to a state that may recognize another user command if the third keyword is recognized and switches to a stop mode state if the fourth key word is recognized.

Also, the control unit recognizes a fifth keyword to switch the stop mode state to the operation stop state.

Also, the apparatus further comprises a driving unit configured to receive a control signal of the control unit, which is intended to control the operation of the device, and to switch to a corresponding mode or perform a corresponding command operation.

Also, the speech receiving unit includes a microphone housing unit that includes a projection member and a microphone, the microphone being installed at an inner side of an air conditioner and the projection member being fixed to an outer side of the air condition in a concave shape towards a front side, and a connection hole connected with the microphone is further provided at the front side.

Also, the microphone housing unit includes two microphones that are respectively installed at lateral portions of both sides of the center of the front of the electric device.

Also, the projection member is curved in an up and down direction so that the wind discharged from the top of the electric device to the bottom of the electric device does not enter the microphone.

Also, the speech receiving unit includes a microphone housing unit that includes a projection member and a microphone, the projection member being fixed to an outer side of the electric device in a concave shape towards a front side, and the microphone being installed inside the projection member.

According to the present invention, as the electric device is operated by speech recognition of the user, inconvenience of the user in manipulating the key input unit provided in the electric device or the key input unit of the remote controller may be solved. In particular, the present invention is more effective when the user has lost the remote controller or came back home after outing.

As the ‘pre-operation speech recognition standby mode’ or ‘standby mode’ is used when the electric device is operated by speech recognition, the electric device may be prevented from being operated in error due to error recognition.

Also, as the ‘speech recognition standby mode during operation’ is used while the electric device is being operated, the electric device may be prevented from being suddenly operated in error.

In particular, if the electric device applied to the present invention is an air conditioner, the noise removing technology is applied thereto and a microphone is built in a projection member, whereby the speech of the user is collected in the microphone and at the same time the wind discharged from the air conditioner does not enter the microphone. As a result, a signal to nose ratio is improved, and thus a high speech recognition rate robust to noise may be provided.

It is to be understood that both the foregoing general description and the following detailed description of the present invention are exemplary and explanatory and are intended to provide further explanation of the specification as claimed.

### BRIEF DESCRIPTION OF THE DRAWINGS

The accompanying drawings, which are included to provide a further understanding of the specification and are incorporated in and constitute a part of this application, illustrate embodiment(s) of the specification and together with the description serve to explain the principle of the specification. In the drawings:

FIG. 1 is a schematic block diagram illustrating an apparatus for driving an electric device in a speech mode in accordance with one embodiment of the present invention;

FIG. 2 is a flow chart illustrating an example of a method for driving an air conditioner of an electric device according to the present invention;

FIG. 3 is a flow chart illustrating another example of a method for driving an air conditioner of an electric device according to the present invention;

FIG. 4 is a flow chart illustrating still another example of a method for driving an air conditioner of an electric device according to the present invention;

FIG. 5 is a flow chart illustrating further still another example of a method for driving an air conditioner of an electric device according to the present invention;

FIG. 6 is a flow chart illustrating an example of a method for driving an electric device according to the present invention;

FIG. 7 is a flow chart illustrating another example of a method for driving an electric device according to the present invention;

FIG. 8 is a flow chart illustrating still another example of a method for driving an electric device according to the present invention;

FIG. 9 is a flow chart illustrating further still another example of a method for driving an electric device according to the present invention;

FIG. 10a to FIG. 10g are diagrams illustrating various embodiments of positions of microphones provided in a stand type air conditioner according to the present invention;

FIG. 10a to FIG. 10g are diagrams illustrating various embodiments of positions of microphones provided in a stand type air conditioner according to the present invention;

FIG. 11 is a diagram illustrating an example of positions of two microphones viewed from the top of an air conditioner when the two microphones are provided as shown in (g) of FIG. 10;

FIG. 12a is a diagram illustrating an example of an air conditioner provided with a microphone housing unit having a projection member and a microphone according to the present invention;

FIG. 12b is a detailed diagram illustrating a projection member of FIG. 12(a);

FIG. 13 is a sectional view illustrating a microphone housing unit according to one embodiment of the present invention;

FIG. 14 is a sectional view illustrating a microphone housing unit according to another embodiment of the present invention; and

FIG. 15a to FIG. 15d are diagrams illustrating various embodiments of a position of a microphone provided in a wall-mounted type air conditioner according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts. The elements and operation of the present invention shown or described by the drawings will be described as at least one embodiment, and it is to be understood that technical spirits and main elements and operation of the present invention are not limited by such embodiment.

Although the terms used in the present specification are selected from generally known and used terms considering their functions in the present specification, the terms can be modified depending on intention of a person skilled in the art, practices, or the advent of new technology. Also, in special case, the terms mentioned in the description of the present specification may be selected by the applicant at his or her discretion, the detailed meanings of which are described in relevant parts of the description herein. Accordingly, the terms used herein should be understood not simply by the actual terms used but by the meaning lying within and the description disclosed herein.

Also, specific structural or functional descriptions of the embodiments according to the concept of the present invention disclosed in this specification are intended to describe the embodiment according to the concept of the present invention. The embodiments according to the concept of the present invention may be implemented in various manners, and it is not to be understood that the embodiments according to the concept of the present specification are limited to the embodiments described in this specification.

Since various modifications may be made in the embodiments according to the present invention, specific embodiments will be illustrated in the drawings and will be described in detail in this specification. However, it is to be understood that the embodiments according to the present invention are not limited to a specific disclosure and include all modifications, equivalents or replacements included in technical spirits and technical scope of the present invention.

And, although the terms indicating the ordinal number such as first and second may be used to describe various elements, the elements should not be restricted by the terms. The terms are used to identify one element from another element. For example, the first element may be referred to as the second element and vice versa within the scope of the present invention.

The present invention is intended to install one microphone (or microphone) in an electric device and operate the electric device directly through speech of a user by using the speech recognition technology. In particular, the present invention is intended to operate the corresponding electric device by using speech only of a user even without manipulating a key input unit provided in a device such as a remote controller, a mobile terminal, and an electric device body.

Also, the present invention is characterized in that a standby mode is applied to at least one of a mode before the electric device is operated using speech and a mode before the operation of the electric device is stopped, whereby a problem that the electric device may be operated in error due to error recognition when the electric device is turned on/off using speech recognition may be solved.

In the present invention, the electric device refers to a product driven using electricity, and may generally be applied to portable electric products, such as a computer, notebook computer, a smart phone, and a table PC, as well as non-portable electronic home appliances such as an air conditioner, a refrigerator, a television, a washing machine, and a dish washer. Accordingly, in the present invention, since the electric device may be used wider and more various applications, it may be limited by the above examples.

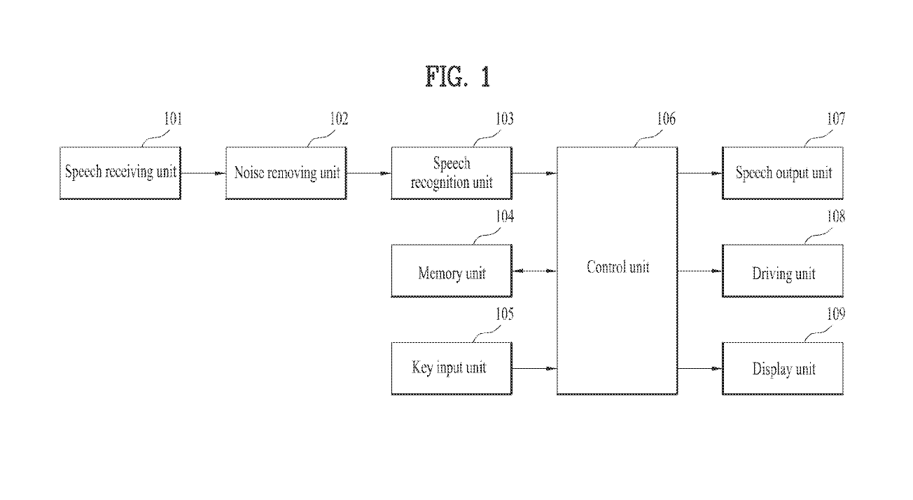

Hereinafter, an apparatus and method for driving an air conditioner of an electric device according to the present invention by using speech will be described with reference to FIG. 1 to FIG. 5.

Generally, the air conditioner is an apparatus for heating and cooling, which is intended to the indoor air at the most suitable state in accordance with usage or object. For example, the air conditioner controls the indoor air at a cooling state in summer, whereas it controls the indoor air at a warming state in winter. Also, the air conditioner controls the indoor humidity and controls the indoor air to a pleasant and clean state.

The air conditioner is classified into a stand type air conditioner of which main body is erectly installed on the bottom of the indoor area in accordance with its type, a ceiling type air conditioner of which main body is arranged on the ceiling of the indoor area, and a wall-mounted air conditioner of which main body is mounted at a sidewall of the indoor area.

A user of the air conditioner generally implements a desired operation of the air conditioner by inputting a control command (on/off, cooling/heating, ventilating, direction, strength, etc.) through a key input unit provided in an air conditioner body or a key input unit provided in a remote controller.

The present invention is intended to install at least one microphone (or microphone) in the air conditioner and operate the air conditioner directly through speech of the user by using the speech recognition technology. In particular, the present invention is intended to directly operate the air conditioner by using speech only of the user even without manipulating the key input unit provided in a device such as the air conditioner body.

In the present invention, all types of air conditioners may be used. For example, examples of the air conditioners may include an air conditioner for cooling, an air conditioner for heating, an air conditioner for cooling and heating, and a multi-air conditioner (or system air conditioner). Also, according to one embodiment of the present invention, examples of the air conditioner may include a stand type air conditioner, a ceiling type air conditioner, and a wall-mounted type air conditioner in accordance with a type of the air conditioner body. In the present invention, the wall-mounted type air conditioner may include a frame type air conditioner and a window type air conditioner.

The air conditioner according to the present invention may have at least one function of cooling and heating, and may further include an air cleaning function and a dehumidifying function. In the present invention, since the air conditioner may be used by wider and various applications, it is not limited to the above examples.

If the air conditioner to which the present invention is applied is a stand type air conditioner, at least two or more microphones are installed in the air conditioner in accordance with one embodiment of the present invention. If the air conditioner to which the present invention is applied is a wall-mounted type air conditioner or a ceiling type air conditioner, at least one or more microphones are installed in the air conditioner in accordance with one embodiment of the present invention. According to one embodiment of the present invention, two microphones are installed in the stand type air conditioner, and one microphone is installed in the wall-mounted type or ceiling type air conditioner.

In particular, as a standby mode is used in the present invention, when the air conditioner is turned on/off using speech recognition, a problem that the air conditioner may be operated due to error recognition even in case of absence of the user may be solved. In other words, the air conditioner is switched from a sleep mode to a standby mode by receiving a speech command language for entering the standby mode, and then is operated by receiving a speech command language for starting the air conditioner. In other words, if the speech command language for entering the standby mode is not input, the air conditioner is not operated even though a speech command for starting or operating the air conditioner is input. According to one embodiment of the present invention, the sleep mode means a speech recognition on/off standby state, and the standby mode means a ready state for speech recognition operation.

FIG. 1 is a schematic block diagram illustrating an apparatus for driving an air conditioner in a speech mode in accordance with one embodiment of the present invention.

Referring to FIG. 1, the apparatus for driving an air conditioner includes a speech receiving unit 101, a nose removing unit 102, a speech recognition unit 103, a memory unit 104, a key input unit 105, a control unit 106, a speech output unit 107, a driving unit 108, and a display unit 109.

The speech receiving unit 101 includes at least one microphone. If the apparatus for driving an air conditioner of FIG. 1 is applied to a stand type air conditioner, the speech receiving unit 101 includes two microphones. If the apparatus for driving an air conditioner of FIG. 1 is applied to a wall-mounted type air conditioner or a ceiling type air conditioner, the speech receiving unit 101 includes one microphone.

The speech receiving module 101 receives an input source that includes speech of the user. In other words, the input source may be daily life noise, air conditioner noise, etc. as well as speech of the user.

The input source input to the speech receiving unit 101 is output to the noise removing unit 102, and the noise removing unit 102 removes other noise (for example, step sound, wind sound, etc.) except for speech of the user from the input source in accordance with one embodiment. In other words, since the noise included in the input source may deteriorate a success rate of speech recognition, it is required to remove noise components before speech recognition. Noise is removed using the existing noises removing algorithm in accordance with one embodiment. In particular, if two microphones are used in the present invention, a two-channel noise removing algorithm may be used as the noise removing algorithm. The noise removing algorithm is implemented by at least one of software, hardware, and firmware in accordance with one embodiment. The noise removing unit 102 may be configured separately as shown in FIG. 1, or may be included in the speech receiving unit 101. However, the noise removing unit 102 is not required necessarily to implement the present invention, and may be used selectively if the need of noise removal is great.

The input source of which noise has been removed by the noise removing unit 102 is output to the speech recognition unit 103. The speech recognition unit 103 extracts a feature of a speech from the input source of which noise has been removed from the input source, recognizes the speech using the extracted feature, and output the recognized speech to the control unit 106. At this time, the feature of the speech is extracted using a Mel-frequency cepstral coefficients (MFCC) system in accordance with one embodiment. Also, speech recognition is performed using a speech recognition algorithm. Generally, examples of the speech recognition algorithm include a dynamic time warping (DTW) algorithm, a hidden markov modeling (HMM) algorithm, and a neural network algorithm. Various factors used for the speech recognition algorithm include a pronouncing method, a speaker, the number of words, language model, word complexity, and a signal to noise ratio (SNR). First of all, examples of the pronouncing method include keyword spotting recognition, isolated word recognition, connected word recognition, and continuous speech recognition. The keyword spotting recognition means that a keyword is only recognized from a normal sentence. The isolated word recognition means that a start and an end of a pronounced word may be identified. The connected word recognition means that a connected word is recognized. The continuous speech recognition means that a normal dialogic sentence is recognized. The speaker includes speaker dependent recognition, speaker independent recognition, and speaker adaptive recognition. The speaker dependent recognition means that speech of a specific speaker is only recognized. The speaker independent recognition means that speech of an unspecified speaker is recognized. The speaker adaptive recognition means that speech recognition is performed by being adaptive to an acoustic feature of a specific speaker together with speaker independent feature.

According to one embodiment of the present invention, speech of the unspecified speaker is recognized using the keyword spotting recognition.

In this case, the control unit 106 identifies whether a keyword is included in the speech input from the unspecified speaker. In the present invention, the keyword is previously stored in the memory unit 104 when the product is commercialized on the market. According to one embodiment, the control unit 106 determines whether one of keywords stored in the memory unit 104 is included in speech of the user. In this case, one keyword may include a word such as noun, adjective, and verb, a phrase, a sentence, and two or more words, and one keyword corresponds to one command.

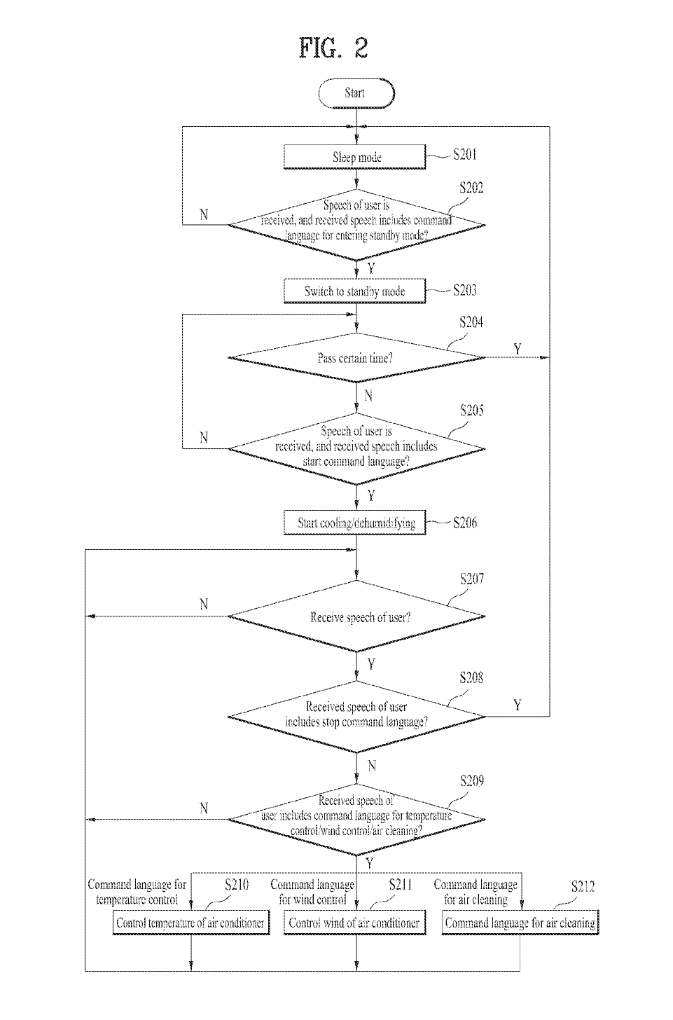

In the embodiments based on FIG. 2 to FIG. 5, which will be described, a keyword for entering a standby mode, a keyword for operating an air conditioner, a keyword for controlling a specific state of an air conditioner, and a key for entering a sleep mode by stopping the operation of the air conditioner are previously stored in the memory unit 104.

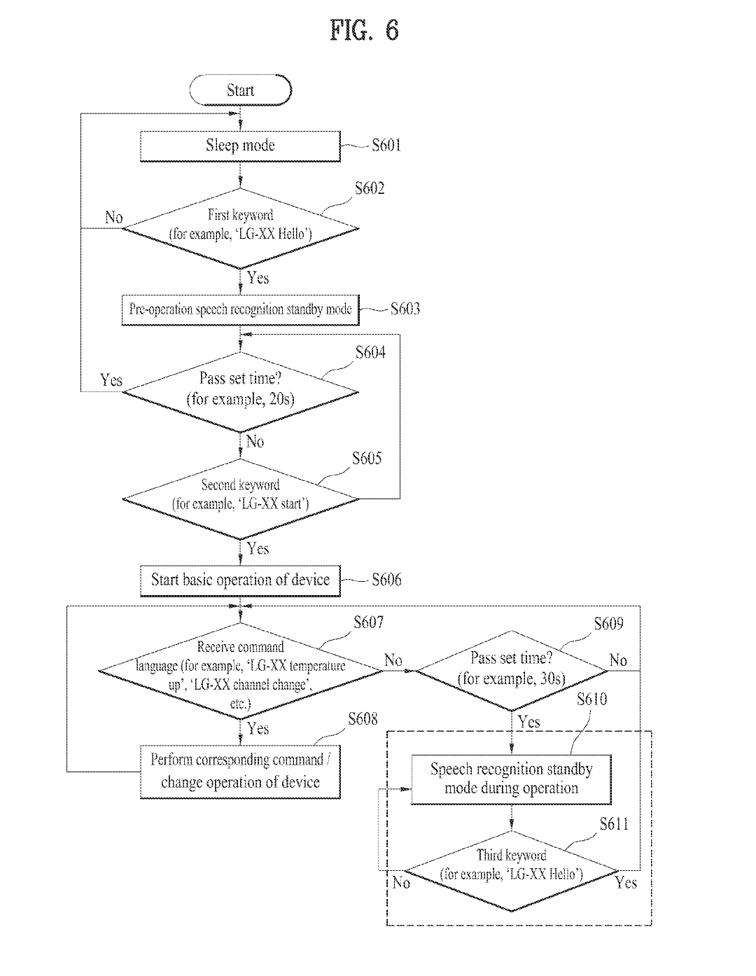

Also, in the embodiments based on FIG. 2 to FIG. 5, which will be described, for convenience of description, the keyword for entering a standby mode will be referred to as a first keyword, the keyword for operating an air conditioner will be referred to as a second keyword, and the key for entering a sleep mode by stopping the operation of the air conditioner will be referred to as a third keyword. For example, according to one embodiment of the present invention, the first keyword is set to “Whisen Hello”, the second keyword is set to “Whisen start”, and the third keyword is set to “Whisen stop”, whereby the set keywords are stored in the memory unit 104. In this case, each keyword is intended to assist understanding of the present invention. Since each keyword may be varied by a designer, it is not limited to the above examples. For example, in the embodiments based on FIG. 6 to FIG. 9, which will be described later, each keyword may be defined differently from another keyword and its description will be made in detail in the corresponding description.

Also, according to one embodiment of the present invention, a corresponding guide message (or response message) according to at least one keyword is also stored in the memory unit 104. For example, according to one embodiment, the guide message corresponding to the keyword “Whisen Hello” is stored as “speech recognition available state”, the guide message corresponding to the keyword “Whisen start” is stored as “Whisen is operated”, and the guide message corresponding to the keyword “Whisen stop” is stored as “Whisen is stopped”. Also, in addition to the guide message, the guide messages corresponding to the keyword for controlling the detailed operation of the air conditioner are previously stored in the memory unit 104. In this case, the guide message is intended to assist understanding of the present invention. Since each guide message may be varied by a designer, it is not limited to the above examples.

The guide message may be output in a speech type through the speech output unit 107, or may be output in a text type through the display unit 109.

In the meantime, if one keyword is included in the speech of the user, the control unit 106 determines whether the keyword may be used in the current state.

According to one embodiment of the present invention, the standby mode is used to solve the problem that the air conditioner is operated due to error recognition even in case of absence of the user when the air conditioner for speech recognition is turned on/off. If the air conditioner is operated due to error recognition when there is no one, a fatal problem that many electric charges may be generated, whereby quality issue such as increase of claims of customers may be caused. Accordingly, it is required so as not to generate error recognition.

To this end, in the present invention, if the keyword “Whisen Hello” corresponding to the command for entering a standby mode is not recognized in the sleep mode state, the air conditioner is not operated, whereby error recognition may be reduced.

In other words, supposing that the current state is the sleep mode state, if the keyword recognized by the speech recognition unit 103 is “Whisen Hello”, the control unit 106 determines that the keyword may be used in the current state. If the keyword recognized by the speech recognition unit 103 is “Whisen start”, the control unit 106 determines that the keyword may not be used in the current state.

If the control unit determines that the keyword recognized by the speech recognition unit 103 may be used in the current state, it determines whether the keyword is the one for entering a specific mode or the one for controlling the operation of the air conditioner.

If the keyword is the one for entering a specific mode, the control unit 106 outputs a control signal for entering the corresponding mode to at least one of the speech output unit 107, the driving unit 108, and the display unit 109. If the keyword is the one for controlling the operation of the air conditioner, the control unit 106 outputs a control signal for performing the corresponding operation to at least one of the speech output unit 107, the driving unit 108, and the display unit 109.

The speech output unit 107 outputs corresponding speech through a speaker in accordance with the control signal of the control unit 106. The driving unit 108 switches the air conditioner to the corresponding mode in accordance with the control signal of the control unit 106 or performs the corresponding operation. The display unit 109 outputs a corresponding text through the screen in accordance with the control signal of the control unit 106.

For example, if the control signal corresponds to the command for entering the standby mode, the speech output unit 107 outputs the guide message corresponding to “speech recognition available state” to notify the standby mode, and the driving unit 108 switches the air conditioner to the standby mode. At this time, the display unit 109 may output “speech recognition available state” in a text type.

According to one embodiment of the present invention, the guide message may be output in a speech type through the speaker of the speech output unit 107 or may be output in a text type through the display unit 109 to notify the standby mode. According to another embodiment of the present invention, a light emitting diode (LED) provided in the air conditioner may be flickered for a certain time (i.e., predefined time) (for example, one minute) or while the standby mode is being maintained, or a text or icon that may allow the user to recognize the standby mode through the screen of the display unit 109. For example, a microphone image on a user interface (UI) of the display unit 109 may be displayed or flickered for a certain time or while the standby mode is being maintained. In this case, the method for recognizing the standby mode is intended to assist understanding of the present invention. All the methods for recognizing the standby mode is applied to the present invention. According to one embodiment of the present invention, after the air conditioner is switched to the standby mode, if the command for starting the air conditioner, that is, “Whisen start” is not received from the user for a certain time (for example, one minute), the standby mode is switched to the sleep mode.

For another example, if the command is intended to increase the current temperature of the air conditioner, such as “Whisen temperature up”, the driving unit 108 increases the temperature of the air conditioner under the control of the control unit 106. At this time, the guide message such as “temperature of air conditioner is increased” may be output in a speech or text type through at least one of the speech output unit 107 and the display unit 109.

Also, if the speech of the user is input while the air conditioner is being operated, and the keyword “Whisen stop” is included in the speech of the user, the air conditioner is switched to the sleep mode.

The key input unit 105 may be the key input unit provided in the air conditioner body, or may be the screen having a touch function. Also, the key input unit 105 may be the remote controller. The screen having the touch function may be the display unit 109. Also, the display unit 109 may be omitted from the air conditioner.

In the meantime, the operation of the air conditioner may be controlled at any time through the key input unit provided in the remote controller or the body of the air conditioner even though the air conditioner is being operated through speech recognition.

FIG. 2 is a flow chart illustrating an example of a method for driving an air conditioner of an electric device according to the present invention.

In FIG. 2, it is assumed that the air conditioner is provided with a cooling/dehumidifying function and an air cleaning function. Also, according to one embodiment of the present invention, the keyword “Whisen Hello” corresponds to a speech command for entering the standby mode, the keyword “Whisen start” corresponds to a speech command for starting the cooling/dehumidifying function, the keyword “Whisen air cleaning” corresponds to a speech command for starting air cleaning, and the keyword “Whisen stop” corresponds to a speech command for switching to the sleep mode by stopping the current operation of the air conditioner. According to one embodiment, the guide message (or response message) of the keyword “Whisen Hello” is “speech recognition available state”, the guide message of the keyword “Whisen start” is “Whisen is operated”, and the guide message of the keyword “Whisen stop” is “Whisen is stopped”.

In other words, if the speech of the user is received in the sleep mode (S201), it is identified whether the command for entering the standby mode, that is, the keyword “Whisen Hello” is included in the received speech of the user (S202). If the keyword “Whisen Hello” is not included in the speech of the user, the speech is disregarded, and the air conditioner does not enter any mode, and does not perform any operation. In other words, the air conditioner is maintained at the sleep mode.

In the meantime, if the keyword “Whisen Hello” is included in the speech of the user, the air conditioner is switched to the standby mode (S203). At this time, the speech output unit 107 outputs the guide message “speech recognition available state” through the speaker under the control of the control unit 106. The guide message may be output in a text type through the display unit 109.

According to one embodiment, after the air conditioner is switched to the standby mode, if the command for starting the air conditioner, that is, “Whisen start” is not received from the user until a certain time (for example, one minute) passes, the air conditioner again returns to the sleep mode (S204). In this way, electricity may be saved, and also the air conditioner may be prevented from being operated in error due to error recognition. For example, after the user utters the keyword “Whisen Hello” for another intention not the intention for operating the air conditioner, if the keyword “Whisen start” is not uttered for a certain time, the air conditioner is switched to the sleep mode. At this time, LED, text, and microphone image may be flickered for a certain time to allow the user to recognize the standby mode. Alternatively, the guide message may be output in a speech type through the speech output unit 107 or in a text type through the display unit 109, whereby the user may utter the keyword “Whisen start”.

In the meantime, if the speech of the user is received before a predetermined time passes after the air conditioner is switched to the standby mode, it is identified whether the command for starting the air conditioner, that is, the keyword “Whisen start” is included in the received speech of the user (S205). If the keyword “Whisen start” is included in the speech of the user, the air conditioner enters a cooling mode and starts at least one of cooling and dehumidifying (S206). At this time, the speech output unit 107 outputs the guide message “Whisen is operated” through the speaker under the control of the control unit 106. The guide message may be output in a text type through the display unit 109. In this case, cooling and dehumidifying may be performed at the same time, or any one of cooling and dehumidifying may be performed.

If the keyword “Whisen start” is not included in the speech of the user at the step S205, the speech is disregarded and the air conditioner is maintained at the standby mode state.

After cooling and dehumidifying starts at the step S206, if the speech of the user is received (S207), it is identified whether the command for stopping the air conditioner, that is, the keyword “Whisen stop” is included in the received speech of the user (S208). At this time, if the keyword “Whisen stop” is included in the received speech of the user, the current operation of the air conditioner is stopped and the air conditioner is switched to the sleep mode. At this time, the speech output unit 107 outputs the guide message “Whisen is stopped” through the speaker under the control of the control unit 106. The guide message may be output in a text type through the display unit 109.

In the meantime, if the keyword “Whisen stop” is not included in the received speech of the user, it is identified whether a keyword corresponding to one of temperature control, wind direction control, and air cleaning is included in the speech of the user (S209). In this case, the keyword for temperature control may be “Whisen temperature up”, and “Whisen temperature down”, and the keyword for wind direction control may be “Whisen strong wind” and “Whisen weak wind”. Each keyword is previously stored in the memory unit 104 in accordance with one embodiment of the present invention.

If the keyword included in the speech of the user is for temperature control at the step S209, the temperature of the air conditioner is increased or decreased through the driving unit 108 to correspond to the keyword (S210). At this time, the corresponding guide message which is previously stored may be output in a speech type through the speech output unit 107, or may be output in a text type through the display unit 109. If the speech of the user is received while the air conditioner is being driven in accordance with its temperature control, the current step returns to the step S208.

If the keyword included in the speech of the user is for wind direction control at the step S209, wind strength of the air conditioner becomes strong or weak through the driving unit 108 to correspond to the keyword (S211). At this time, the corresponding guide message which is previously stored may be output in a speech type through the speech output unit 107, or may be output in a text type through the display unit 109. If the speech of the user is received while the air conditioner is being driven in accordance with its wind direction control, the current step returns to the step S208.

If the keyword included in the speech of the user is for air cleaning at the step S209, the air conditioner is driven at an air cleaning mode through the driving unit 108 (S212). At this time, the corresponding guide message which is previously stored may be output in a speech type through the speech output unit 107, or may be output in a text type through the display unit 109. If the speech of the user is received while the air conditioner is being driven at the air cleaning mode, the current step returns to the step S208.

According to another embodiment of the present invention, when the user utters the speech command “Whisen stop”, the air conditioner may be switched to the sleep mode after LED is flickered for a certain time (for example, one minute) without being switched to the sleep mode immediately. At this time, the guide message indicating that the air conditioner will be stopped soon may be output in a speech or text type. Also, according to the present invention, if the keyword (for example, Whisen continue operation) for continuously operating the air conditioner is input while LED is being flickered, flickering is stopped and the air conditioner may return to the operation state before the speech command “Whisen stop” is received.

According to the present invention, as shown in FIG. 2, the operation of the air conditioner may be controlled through the key input unit provided in the remote controller or the air conditioner body or the touch screen at any time even though the air conditioner is being driven through speech recognition.

In the meantime, according to the present invention, the standby mode may be used even when the operation of the air conditioner is stopped and the air conditioner is switched to the sleep mode. In other words, according to the present invention, in order to prevent the air conditioner from being stopped due to error of the user or error recognition, if the user utters the speech command for stopping the air conditioner, the air conditioner is switched to the standby mode and then switched to the sleep mode to stop the operation of the air conditioner if the user utters speech command for identifying operation stop.

In the present invention, the standby mode for identifying start of the air conditioner will be referred to as a start standby mode, and the standby mode for identifying stop of the air conditioner will be referred to as a stop standby mode.

In the present invention, the keyword for entering the start standby mode may be equal to or different from the keyword for identifying operation stop. For example, the keyword for entering the start standby mode and the keyword for identifying operation stop may be “Whisen Hello” equally to each other. If these two keywords are the same as each other, the control unit 106 determines the state of the air conditioner before the keyword “Whisen Hello” is received and decides whether to enter the start standby mode or the sleep mode in accordance with one embodiment of the present invention. In other words, if the keyword “Whisen Hello” is received in the sleep mode, the air conditioner is switched to the start standby mode. If the keyword “Whisen Hello” is received in the stop standby mode, the operation of the air conditioner is stopped and the air conditioner switched to the sleep mode. For another example, the keyword for entering the start standby mode may be set to “Whisen Hello”, whereas the keyword for identifying operation stop may be set to “Whisen stop”. Even though different keywords are received, the control unit 106 performs a control operation to enter the corresponding mode on the basis of the state of the air conditioner just before the corresponding keyword is received.

According to one embodiment of the present invention, the operation state of the air conditioner just before the air conditioner is switched to the stop standby mode may be maintained continuously even in the stop standby mode. According to another embodiment of the present invention, the operation of the air conditioner may be decelerated at the lowest wind strength in the stop standby mode. The operation of the air conditioner in the stop standby mode is intended to assist understanding of the present invention. Since the operation of the air conditioner may be varied by a designer, it is not limited to the above examples.

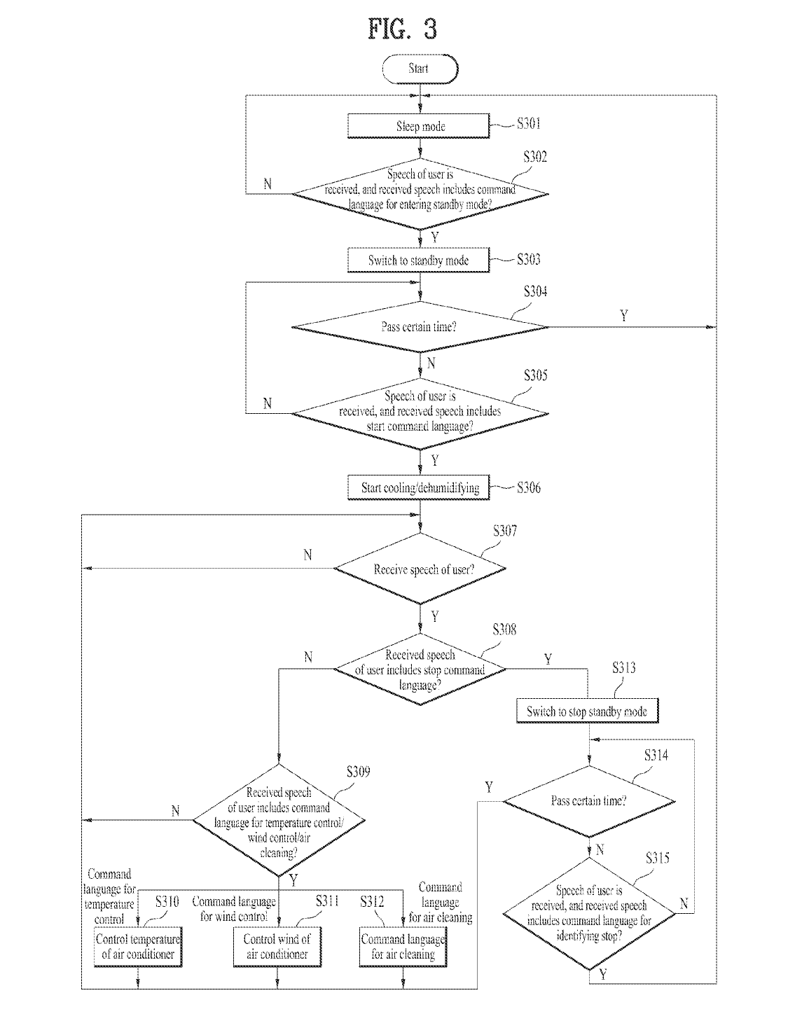

FIG. 3 is a flow chart illustrating another example of a method for driving an air conditioner of an electric device according to the present invention.

In FIG. 3, it is assumed that the air conditioner is provided with a cooling/dehumidifying function and an air cleaning function. Also, according to one embodiment of the present invention, the keyword “Whisen Hello” corresponds to a speech command for entering the standby mode in the sleep mode, the keyword “Whisen start” corresponds to a speech command for starting the cooling/dehumidifying function, the keyword “Whisen air cleaning” corresponds to a speech command for starting air cleaning, the keyword “Whisen stop” corresponds to a speech command for switching to the stop standby mode, and the keyword “Whisen Hello” corresponds to a speech command for switching from the stop standby mode to the sleep mode by stopping the current operation of the air conditioner. According to one embodiment, the guide message (or response message) of the keyword “Whisen Hello” which is the command for entering the start standby mode is “speech recognition available state”, the guide message of the keyword “Whisen start” is “Whisen is operated”, the guide message of the keyword “Whisen stop” is “Will you stop Whisen?”, and the guide message of the keyword “Whisen Hello” which is the command for switching from the stop standby mode to the sleep mode is “Whisen is stopped”.

In other words, if the speech of the user is received in the sleep mode (S301), it is identified whether the command for entering the start standby mode, that is, the keyword “Whisen Hello” is included in the received speech of the user (S302). If the keyword “Whisen Hello” is not included in the speech of the user, the speech is disregarded, and the air conditioner does not enter any mode, and does not perform any operation either. In other words, the air conditioner is maintained at the sleep mode.

In the meantime, if the keyword “Whisen Hello” is included in the speech of the user, the air conditioner is switched to the start standby mode (S303). At this time, the speech output unit 107 outputs the guide message “speech recognition available state” through the speaker under the control of the control unit 106. The guide message may be output in a text type through the display unit 109.

After the air conditioner is switched to the standby mode, if the command for starting the air conditioner, that is, “Whisen start” is not received from the user until a certain time (for example, one minute) passes, the air conditioner again returns to the sleep mode (S304). In this way, electricity may be saved, and also the air conditioner may be prevented from being operated in error due to error recognition. At this time, LED, text, and microphone image may be flickered for a certain time to allow the user to recognize the standby mode. Alternatively, the guide message may be output in a speech type through the speech output unit 107 or in a text type through the display unit 109, whereby the user may utter the keyword “Whisen start”.

In the meantime, if the speech of the user is received before a predetermined time passes after the air conditioner is switched to the start standby mode, it is identified whether the command for starting the air conditioner, that is, the keyword “Whisen start” is included in the received speech of the user (S305). If the keyword “Whisen start” is included in the speech of the user, the air conditioner enters a cooling mode and starts at least one of cooling and dehumidifying (S306). At this time, the speech output unit 107 outputs the guide message “Whisen is operated” through the speaker under the control of the control unit 106. The guide message may be output in a text type through the display unit 109. In this case, cooling and dehumidifying may be performed at the same time, or any one of cooling and dehumidifying may be performed.

If the keyword “Whisen start” is not included in the speech of the user at the step S305, the speech is disregarded and the air conditioner is maintained at the start standby mode state.

After cooling and dehumidifying starts at the step S306, if the speech of the user is received (S307), it is identified whether the command for entering the stop standby mode, that is, the keyword “Whisen stop” is included in the received speech of the user (S308).

At this time, if the keyword “Whisen stop” is not included in the received speech of the user, it is identified whether the keyword corresponding to one of temperature control, wind direction control, and air cleaning is included in the received speech of the user (S309). In this case, the temperature control keyword may be “Whisen temperature up” and “Whisen temperature down”, and the keyword for wind direction control may be “Whisen strong wind” and “Whisen weak wind”. Each keyword is previously stored in the memory unit 104 in accordance with one embodiment of the present invention.

If the keyword included in the speech of the user is for temperature control at the step S309, the temperature of the air conditioner is increased or decreased through the driving unit 108 to correspond to the keyword (S310). At this time, the corresponding guide message which is previously stored may be output in a speech type through the speech output unit 107, or may be output in a text type through the display unit 109. If the speech of the user is received while the air conditioner is being driven in accordance with its temperature control, the current step returns to the step S308.

If the keyword included in the speech of the user is for wind direction control at the step S309, wind strength of the air conditioner becomes strong or weak through the driving unit 108 to correspond to the keyword (S311). At this time, the corresponding guide message which is previously stored may be output in a speech type through the speech output unit 107, or may be output in a text type through the display unit 109. If the speech of the user is received while the air conditioner is being driven in accordance with its wind direction control, the current step returns to the step S308.

If the keyword included in the speech of the user is for air cleaning at the step S309, the air conditioner is driven at an air cleaning mode through the driving unit 108 (S312). At this time, the corresponding guide message which is previously stored may be output in a speech type through the speech output unit 107, or may be output in a text type through the display unit 109. If the speech of the user is received while the air conditioner is being driven at the air cleaning mode, the current step returns to the step S308.

In the meantime, if the keyword “Whisen stop” is included in the speech of the user at the step S308, the air conditioner is switched to the stop standby mode (S313). At this time, the speech output unit 107 outputs the guide message “Will you stop Whisen?” through the speaker under the control of the control unit 106. The guide message may be output in a text type through the display unit 109.

According to one embodiment of the present invention, the operation state of the air conditioner operated just before the air conditioner is switched to the stop standby mode may be maintained continuously even in the stop standby mode. For example, if the air conditioner is being operated at wind strength of the fourth stage, it is operated continuously at wind strength of the fourth stage even in case of the stop standby mode.

According to another embodiment of the present invention, the operation of the air conditioner may be decelerated at the lowest wind strength in the stop standby mode. For example, if the air conditioner is being operated at wind strength of the fourth stage, it is operated at wind strength of the first stage in case of the stop standby mode.

After the air conditioner is switched to the stop standby mode at the step S313, it is identified whether the speech command for identifying stop of the air conditioner is received from the user for a certain time (for example, one minute) (S314).

If the speech command for identifying stop of the air conditioner is not received from the user until a certain time (for example, one minute) passes after the air conditioner is switched to the stop standby mode, the air conditioner returns to the step S307 and maintains the previous driving state. In this case, LED, text, and microphone image may be flickered for a certain time to allow the user to recognize the stop standby mode. Alternatively, the guide message may be output in a speech type through the speech output unit 107 or in a text type through the display unit 109, whereby the user may utter the speech command for identifying stop of the air conditioner.

For example, it is assumed that the air conditioner enters the stop standby mode and is decelerated at the wind strength of the first stage as the speech command for stopping the air conditioner is input while the air conditioner is being operated at the wind strength of the fourth stage. In this case, if the speech command for identifying stop of the air conditioner is not input for a certain time, the air conditioner returns from the wind strength of the first stage to the wind strength of the fourth stage.

In the meantime, if the speech of the user is received before a certain time passes after the air conditioner is switched to the stop standby mode, and if the command for identifying stop of the air conditioner, that is, the keyword “Whisen Hello” is included in the received speech of the user, the operation of the air conditioner is completely stopped and switched to the sleep mode (S315). At this time, the speech output unit 107 outputs the guide message “Whisen is stopped” in a speech type under the control of the control unit 106. The guide message may be output in a text type through the display unit 109.

It is assumed that the operation state of the air conditioner operated just before the stop standby mode is maintained continuously. In this case, if the speech command for identifying stop of the air conditioner is not received until the certain time passes (S314), the stop standby mode is released in accordance with one embodiment of the present invention.

According to another embodiment of the present invention, when the user utters the speech command “Whisen stop”, the air conditioner may not be switched to the stop standby mode but be switched to the sleep mode without the command for identifying stop after using UI only such as LED flickering. For example, if the user inputs the speech command “Whisen stop”, the air conditioner is operated normally and its operation is automatically stopped after LED is flickered for a certain time, whereby the air conditioner may be switched to the sleep mode. At this time, the guide message indicating that the operation of the air conditioner will be stopped soon may be output in a speech type or text type. Also, in the present invention, if the keyword (for example, Whisen continue operation) for continuously operating the air conditioner is input while LED is being flickered, flickering is stopped and the air conditioner may return to the operation state of the air conditioner operated just before the speech command “Whisen stop” is received.

According to still another embodiment of the present invention, if the user inputs the speech command for stopping the air conditioner, the air conditioner may enter the stop standby mode and at the same time LED may be flickered for a certain time. At this time, the guide message “Will you stop Whisen?” is output in a speech type or text type to receive the speech command for identifying stop from the user. When the air conditioner enters the stop standby mode, the same process as that described above will be performed in accordance with one embodiment.

In the present invention, the operation of the air conditioner may be controlled through the key input unit provided in the remote controller or the air conditioner body or the touch screen at any time even though the air conditioner is being operated through speech recognition.

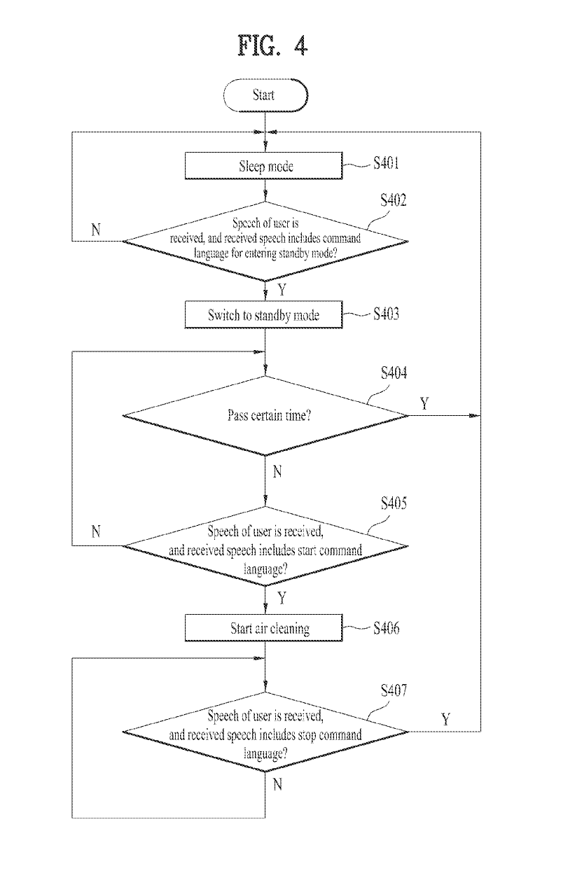

FIG. 4 is a flow chart illustrating still another example of a method for driving an air conditioner of an electric device according to the present invention. In particular, FIG. 4 is a flow chart illustrating a method for driving an air conditioner when a start standby mode is only applied to the air conditioner.

In FIG. 4, it is assumed that the air conditioner is provided with an air cleaning function only. Also, according to one embodiment of the present invention, the keyword “Whisen Hello” corresponds to a speech command for entering the standby mode (that is, start standby mode), the keyword “Whisen air cleaning” corresponds to a speech command for starting air cleaning, and the keyword “Whisen stop” corresponds to a speech command for switching to the sleep mode by stopping the air cleaning operation.

In other words, if the speech of the user is input in the sleep mode (S401), it is identified whether the command for entering the standby mode, that is, the keyword “Whisen Hello” is included in the input speech of the user (S402). If the keyword “Whisen Hello” is not included in the speech of the user, the speech is disregarded, and the air conditioner does not enter any mode, and does not perform any operation either. In other words, the air conditioner is maintained at the sleep mode.

In the meantime, if the keyword “Whisen Hello” is included in the speech of the user, the air conditioner is switched to the standby mode (S403). At this time, the speech output unit 107 outputs the guide message “speech recognition available state” through the speaker under the control of the control unit 106. The guide message may be output in a text type through the display unit 109.

According to one embodiment, after the air conditioner is switched to the standby mode, if the command for starting air cleaning, that is, “Whisen air cleaning” is not received from the user until a certain time (for example, one minute) passes, the air conditioner again returns to the sleep mode (S404). In this way, electricity may be saved, and also the air conditioner may be prevented from being operated in error due to error recognition. At this time, LED, text, and microphone image may be flickered for a certain time to allow the user to recognize the start standby mode. Alternatively, the guide message may be output in a speech type through the speech output unit 107 or in a text type through the display unit 109, whereby the user may utter the keyword “Whisen air cleaning”.

In the meantime, if the speech of the user is received before a predetermined time passes after the air conditioner is switched to the standby mode, it is identified whether the command for starting air cleaning, that is, the keyword “Whisen air cleaning” is included in the received speech of the user (S405). If the keyword “Whisen air cleaning” is included in the speech of the user, the air conditioner enters the air cleaning mode and starts air cleaning (S406). At this time, the speech output unit 107 outputs the guide message “air cleaning starts” through the speaker under the control of the control unit 106. The guide message may be output in a text type through the display unit 109.

If the keyword “Whisen air cleaning” is not included in the speech of the user at the step S405, the speech is disregarded and the air conditioner is maintained at the standby mode state.

If the speech of the user is received while the air conditioner is being operated at the air cleaning mode at the step S406, it is identified whether the command for stopping air cleaning, that is, the keyword “Whisen stop” is included in the received speech of the user (S407). At this time, if the keyword “Whisen stop” is included in the received speech of the user, the air cleaning operation of the air conditioner is stopped and the air conditioner is switched to the sleep mode. At this time, the speech output unit 107 outputs the guide message “air cleaning is stopped” through the speaker under the control of the control unit 106. The guide message may be output in a text type through the display unit 109.

In the meantime, if the keyword “Whisen stop” is not included in the received speech of the user, the speech is disregarded, and the air conditioner is driven continuously at the air cleaning state.

According to another embodiment of the present invention, when the user utters the speech command “Whisen stop”, the air conditioner may not be switched to the sleep mode immediately but be switched to the sleep mode after LED is flickered for a certain time (for example, one minute). At this time, the guide message indicating that the operation (or air cleaning) of the air conditioner will be stopped soon may be output in a speech type or text type. Also, in the present invention, if the keyword (for example, Whisen continue operation) for continuously operating the air conditioner is input while LED is being flickered, flickering is stopped and the air conditioner may return to the operation state of the air conditioner operated just before the speech command “Whisen stop” is received.

In the present invention, the operation of the air conditioner may be controlled through the key input unit provided in the remote controller or the air conditioner body or the touch screen at any time even though the air conditioner is being operated through speech recognition.

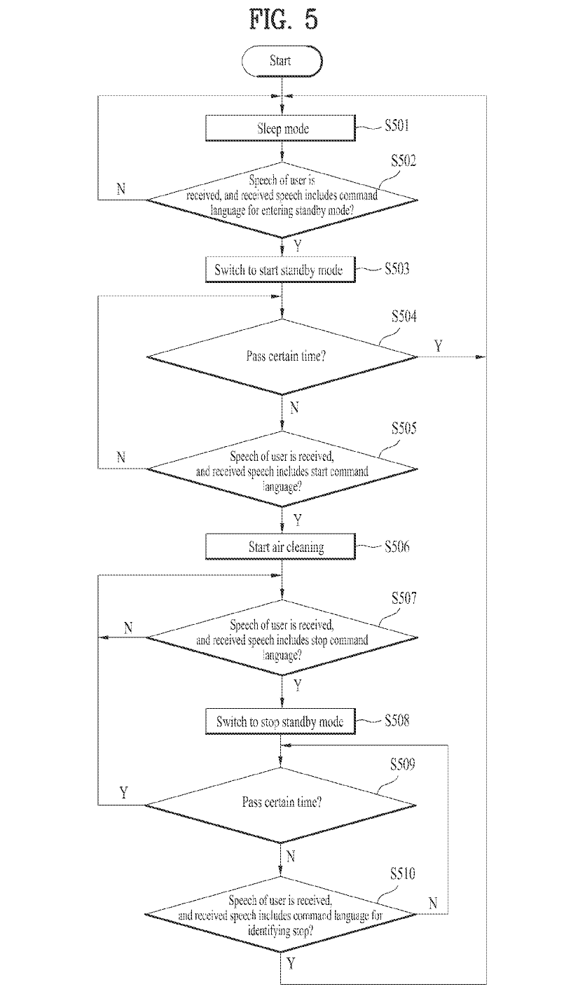

FIG. 5 is a flow chart illustrating further still another example of a method for driving an air conditioner of an electric device according to the present invention. In particular, FIG. 5 is a flow chart illustrating a method for driving an air conditioner provided with an air cleaning function only when both a start standby mode and a stop standby mode are applied to the air conditioner. In other words, the process of FIG. 5 is the same as that of FIG. 5 except for the process performed after the speech command for stopping the operation of the air conditioner is input. Accordingly, since steps S501 to S507 will be understood with reference to the steps S401 to S407 of FIG. 4, their detailed description will be omitted. In FIG. 5, step S508 and its following steps will be described. At this time, a portion which will not be described in FIG. 5 depends on the description of FIG. 4.

In other words, in the same manner as FIG. 4, in FIG. 5, if the speech command for entering the start standby mode, that is, “Whisen Hello” is received in the sleep mode, the air conditioner is switched to the start standby mode. At this time, the speech output unit 107 outputs the guide message “speech recognition available state” through the speaker under the control of the control unit 106. The guide message may be output in a text type through the display unit 109. Also, after the air conditioner is switched to the standby mode, if the command for starting air cleaning, that is, “Whisen air cleaning” is not received from the user until a certain time passes, the air conditioner returns to the sleep mode. Also, LED, text, and microphone image may be flickered for a certain time to allow the user to recognize the start standby mode.

However, if the speech command for starting air cleaning, that is, “Whisen air cleaning” is received before a predetermined time passes, the air conditioner enters the air cleaning mode and starts air cleaning. At this time, the speech output unit 107 outputs the guide message “air cleaning starts” through the speaker under the control of the control unit 106. The guide message may be output in a text type through the display unit 109.

If the speech of the user is received while the air conditioner is being operated at the air cleaning mode, and if the command for stopping air cleaning, that is, “Whisen stop” is included in the received speech of the user (S507), the air conditioner is switched to the stop standby mode (S508). In FIG. 5, the guide message corresponding to “Whisen stop” is set to “Will you stop air cleaning?” and previously stored in the memory unit 104 unlike FIG. 4. In this case, the air conditioner is switched to the stop standby mode, and the speech output unit 107 outputs the guide message “Will you stop air cleaning?” under the control of the control unit 106. The guide message may be output in a text type through the display unit 109.

According to one embodiment of the present invention, the operation state of the air conditioner operated just before the stop standby mode may be maintained continuously. For example, if the air cleaning is being operated at the fourth stage, it is operated continuously at the fourth stage even in case of the stop standby mode. According to another embodiment of the present invention, the air cleaning may be performed at the lowest stage in the stop standby mode. For example, if the air cleaning is being operated at the fourth stage, it is operated at the first stage in case of the stop standby mode.

After the air conditioner is switched to the stop standby mode at the step S508, it is identified whether the speech command for identifying stop of the air cleaning is received from the user for a certain time (for example, one minute) (S509).

If the speech command for identifying stop of the air cleaning is not received from the user until a certain time (for example, one minute) passes after the air conditioner is switched to the stop standby mode, the air conditioner returns to the step S507 and maintains the previous air cleaning driving state. In this case, LED, text, and microphone image may be flickered for a certain time to allow the user to recognize the stop standby mode. Alternatively, the guide message may be output in a speech type through the speech output unit 107 or in a text type through the display unit 109, whereby the user may utter the speech command for identifying stop of the air cleaning.

In the meantime, if the speech of the user is received before a certain time passes after the air conditioner is switched to the stop standby mode, and if the command for identifying stop of the air cleaning, for example, the keyword “Whisen Hello” or “Whisen stop” is included in the received speech of the user, the air cleaning operation of the air conditioner is completely stopped and the air conditioner is switched to the sleep mode (S510). In FIG. 5, the guide message corresponding to the command for identifying stop of air cleaning is set to “air cleaning is stopped” and previously stored in the memory unit 104 in accordance with one embodiment. In this case, the air conditioner is switched to the sleep mode, and the speech output unit 107 outputs the guide message “air cleaning is stopped” under the control of the control unit 106. The guide message may be output in a text type through the display unit 109.

It is assumed that the operation state of the air conditioner operated just before the stop standby mode is maintained continuously even in the stop standby mode. In this case, if the speech command for identifying stop of the air cleaning is not received until the certain time passes (S509), the stop standby mode is released in accordance with one embodiment of the present invention.

According to another embodiment of the present invention, when the user utters the speech command “Whisen stop”, the air conditioner may not be switched to the stop standby mode but be switched to the sleep mode without the command for identifying stop after using UI only such as LED flickering. For example, if the user inputs the speech command “Whisen stop”, the air conditioner may be operated normally at the air cleaning mode and the air cleaning operation is stopped after LED is flickered for a certain time, whereby the air conditioner may be switched to the sleep mode automatically. At this time, the guide message indicating that the air cleaning operation will be stopped soon may be output in a speech type or text type. Also, in the present invention, if the keyword (for example, Whisen continue operation) for continuously operating the air cleaning is input while LED is being flickered, flickering is stopped and the air conditioner may return to the operation state of the air conditioner operated just before the speech command “Whisen stop” is received.

According to still another embodiment of the present invention, if the user inputs the speech command for stopping the air cleaning, the air conditioner may enter the stop standby mode and at the same time LED may be flickered for a certain time. At this time, the guide message “Will you stop air cleaning?” is output in a speech type or text type to receive the speech command for identifying stop from the user. When the air conditioner enters the stop standby mode, the same process as that described above will be performed in accordance with one embodiment.

Also, as a method for preventing error recognition from occurring, in the present invention, a separate speech recognition algorithm may be used for each mode. For example, at least one of a speech recognition algorithm of a command for entering a standby mode, a speech recognition algorithm of a command for entering a start mode, a speech recognition algorithm of a command for temperature control, wind direction control, and air cleaning, and a speech recognition algorithm of a command for entering a stop mode (that is, sleep mode) may be used differently.

According to one embodiment of the present invention, the keyword per mode used in the present invention is previously stored in the memory unit 104 when the product is commercialized on the market. According to another embodiment of the present invention, each keyword may be edited and deleted. To this end, a menu for editing a keyword is provided. The menu for editing a keyword may be entered through the remote controller, or may be entered through the key input unit of the air conditioner body or the touch screen. In other words, at least one of the keyword for entering a standby mode, the keyword for entering a start mode, the keyword for temperature control, wind direction control, and air cleaning, and the keyword for entering a stop mode may be switched to another keyword. For example, the keyword “Whisen Hello” may be switched to a keyword “ready”. For another example, after a plurality of keywords per mode are stored when the product is commercialized on the market, one of the keywords may be selected by the user. For example, after a plurality of keywords for entering the standby mode may be stored when the product is commercialized on the market, one of the keywords may be selected by the user. In this case, the desire of the user who desires to change the keyword per mode in accordance with his/her taste may be fulfilled, and convenience may be improved when a foreigner uses the air conditioner.

Also, the present invention may provide a menu for turning on/off a speech recognition function. Speech recognition may be set automatically or manually through this menu, and may be set to be implemented at a specific time or date only.

Hereinafter, a method for driving an electric device using speech recognition will be described with reference to FIG. 6 to FIG. 9. In this regard, the electric device applied to the embodiments of the present invention includes all of normal electric products, and its examples may include a portable electric device (notebook computer, smart phone, etc.) and a non-portable electric device (air conditioner, refrigerator, washing machine, etc.). Also, basic configuration of the electric device to which the embodiments of FIG. 6 to FIG. 9 are applied may be the same as that of FIG. 1. Accordingly, the method for driving an electric device using speech recognition in accordance with the embodiments of FIG. 6 to FIG. 9 may be understood by the operation based on the control unit 106 of FIG. 1.

FIG. 6 is a flow chart illustrating an example of a method for driving an electric device according to the present invention.

First of all, the control unit 106 determines whether a first keyword (for example, “LG-XX, Hello”) previously set in a sleep mode (S601) state is recognized through the speech recognition unit 103 (S602). In this regard, the sleep mode S601 state means an operation stop state, and corresponds to the state that a minimum power for recognizing the first keyword is only driven.

Also, the first keyword may include a connected word of company name (‘LG’)—brand name (‘XX’) and a specific keyword (‘hi’), such as “LG-XX, Hello”. For example, in case of another product (for example, ‘YY’) of the same company (for example, ‘LG’), the first keyword may be “LG-YY, Hello”. Accordingly, the user may conveniently apply the same speech recognition method to all the speech recognition products manufactured by the same company even though the user does not remember a separate speech recognition manual per product. In more detail, if an air conditioner (for example, air conditioner (for example, brand name ‘Whisen’) of LG), TV (for example, brand name ‘XCANVAS’) and a smart phone (for example, brand name ‘Optimus’) of the same company exist in the living room of a home, the user may speak the first keyword in accordance with the product desired to be operated, for example, “LG-Whisen Hello” if the user desires to operate the air conditioner, “LG-XCANVAS, Hello” if the user desires to operate the TV, and “LG-Optimus, Hello” if the user desires to operate the smart phone. Also, the company name may be omitted, whereby the first keyword may be implemented in brief such as “Whisen Hello”, “X-CANVAS, Hello” and “Optimus, Hello”. Also, the connected word may be omitted, whereby the first keyword may be implanted in brief such as “LG Whisen”, “LG XCANVAS” and “LG Optimus”. Also, instead of a specific brand name, the keyword such as “power operation” and “power start” may be implemented. Also, the first keyword may be implemented in English such as “LG-XX, Hello”. This may be implemented by selecting speech recognition in another language (for example, English) not the Korean language in a user initial setting condition. It will be apparent that various examples constituting the first keyword as above may equally be applied to a second keyword, a third keyword, a fourth keyword, a fifth keyword, and a user command, which will be described later.

If the first keyword is not recognized at the step S602, the sleep mode (S601) state is maintained continuously. In other words, only the first keyword may be recognized in the sleep mode state, and the electric device may be operated at next state only if first keyword is recognized. In other words, the electric device is not operated for the other speech recognition languages except for the first keyword in the sleep mode (S601) state.

If the first keyword is recognized at the step S602, the control unit 106 switches the sleep mode state (S601) to a ‘pre-operation speech recognition standby mode’ state which is next state (S603). The pre-operation speech recognition standby mode state is similar to the start standby mode described in the aforementioned embodiments (FIG. 2 to FIG. 5), and means a speech recognition standby state for operating the electric device. In this regard, if the electric device enters the pre-operation speech recognition standby mode state, the control unit 106 may perform an alarm function to notify the user of the pre-operation speech recognition standby mode state. For example, the guide message “speech recognition available state” may be output through the speaker, or may be output in a text type through the display unit 109. Also, the guide message may be displayed using a visual display means (for example, LED device). In this regard, the pre-operation speech recognition standby mode state is the state before the electric device is basically operated, and requires the minimum power to perform the speech recognition function and the alarm function.

Also, after the electric device is switched to the pre-operation speech recognition standby mode state (S603), the control unit 106 identifies whether the second keyword (for example, “LG-XX start” is recognized within a predefined time (for example, 20 seconds) (S605). If the second keyword is recognized within the predefined time (for example, 20 seconds), the control unit 106 starts the basis operation of the corresponding electric device by controlling the driving unit 108 (S606). On the other hand, if the second keyword is not recognized within the predefined time, the state (S603) returns to the aforementioned sleep mode state (S601).

In other words, the control unit 106 recognizes the operation of the electric device through speech recognition only if the user utters the first keyword (for example, “LG-XX, Hello”) and the second keyword (for example, “LG-XX start”) within the predefined time, and performs the basis operation of the electric device. Accordingly, since the operation of the electric device is started after the speech recognition is performed at least twice, the electric device is prevented from being operated in error due to error recognition of the speech. Also, in case of the electric device (for example, air conditioner, refrigerator, washing machine, etc.) having high power consumption, use of electricity may be saved in such a manner that the electric device is prevented from being operated in error.

The basic operation of the electric device at the step S606 may be driven by the previously set operation per electric device. For example, start of cooling at a basic temperature may be set as the basic operation of the air conditioner, automatic reception of a previous watching channel may be set as the basic operation of the TV, and display of a main menu on the screen may be set as the basic operation of the smart phone.

In order to change the basic operation state (S606) of the electric device, another user command language should be recognized (S607 and S608). The user command language is recognized in such a manner that a user command language corresponding to at least any one of a set of a plurality of user command languages which are previously is received and recognized. For example, the user command language set may include “LG-XX temperature down”, “LG-XX temperature up”, “LG-XX strong wind”, “LG-XX call”, “LG-XX channel change” and “LG-XX, Today weather?”, or may include “temperature down”, “temperature up”, “strong wind”, “call”, “channel change” and “Today weather?”. In this way, various speech recognition command languages may be set in accordance with the feature of the corresponding electric device. Accordingly, if the user command language is recognized, the control unit changes the operation of the electric device from the basic operation to the operation suitable for the corresponding command language through the driving unit 108 (S608).

On the other hand, if another language is not recognized during basic operation (S606) or while the command is being performed (S608) within a predefined time (S609), the control unit 106 switches the electric device to a ‘speech recognition standby mode during operation’ state (S610). For example, if the basic operation (S606) state is started, the control unit 106 performs the corresponding basic operation and at the same time starts to count the predefined time (for example, 30 seconds). As a result, the control unit 106 always identifies whether a new user command language is recognized for the predefined time (for example, 30 seconds) after the second keyword is recognized. If the new user command language is not recognized, the control unit 106 switches the electric device to the ‘speech recognition standby mode during operation’ state (S610). Also, if the state (S608) for performing the command is started, the control unit 106 performs the corresponding command and at the same time starts to count the predefined time (for example, 30 seconds). As a result, the control unit 106 continues to identify whether the new user command language is recognized for the predefined time (for example, 30 seconds) after the user command language uttered most recently is recognized. If another user command language is not recognized, the control unit 106 switches the electric device to the ‘speech recognition standby mode during operation’ state (S610).

The ‘speech recognition standby mode during operation’ state (S610) is the same as the ‘pre-operation speech recognition standby mode’ state (S603) in view of the standby state for performing speech recognition but is different from the ‘pre-operation speech recognition standby mode’ state in view of the presence of the current operation state of the corresponding electric device. In other words, the ‘speech recognition standby mode during operation’ state (S610) means the standby state for next speech recognition if no user command is recognized during the operation of the electric device for the predefined time (for example, 30 seconds).

In this embodiment, the third keyword (for example, “LG-XX, Hello”) should first be recognized to get out of the ‘speech recognition standby mode during operation’ state (S610). In other words, in order to perform another user command at the ‘speech recognition standby mode during operation’ state (S610), is it is required that the third keyword (for example, “LG-XX, Hello”), which is previously defined, should first be recognized (S611). Accordingly, it is advantageous in that the electric device is prevented from being operated in error due to error recognition of the speech.

For example, if the third keyword (for example, “LG-XX, Hello”) is recognized (S611) at the ‘speech recognition standby mode during operation’ state (S610), the control unit 106 is ready for recognizing additional user command for the predefined time (for example, 30 seconds). If the user command is recognized within the predefined time (S607), the control unit 106 performs the corresponding command (S608). On the other hand, if the user command is not recognized within the predefined time, the current state returns to the speech recognition standby mode during operation′ state (S610) (S609->S610). In this regard, the ‘speech recognition standby mode during operation’ may mean the state that includes the step S610 and the step S611 as shown in a dotted block of FIG. 6.

Preferably, the first keyword, the second keyword and the user command language, which are applied to the above embodiment, are configured differently from one another. Also, the first keyword and the third keyword are not intended for the operation of the electric device but intended to request the step of being ready for next speech recognition for the operation of the electric device. Accordingly, it is preferable that the first keyword and the third keyword are configured as the same keyword (for example, “LG-XX, Hello”). However, as described above, if the keyword “LG-XX power start” is used as the first keyword, the first keyword may be configured differently from the third keyword.

Herein, the user command at step 607 can be one of an operation command and an inquiry command. The operation command relates to a command corresponding to an operation of the electronic device. The examples of the operation command may include “temperature down”, “temperature up”, “strong wind” and “channel change”.

On the other hand, the inquiry command relates to a command corresponding to a searching operation of the electronic device that is irrespective of the driving the electronic device itself. The examples of the inquiry command may include “Today weather?” and “Find restaurant?”. That is, during the ‘speech recognition standby mode during operation’ state, after the third keyword (i.e., “LG-XX Hello”) is recognized, the control unit can search the inquiry command. For example, if a user speaks as like “LG-XX Hello, Today weather?” during the ‘speech recognition standby mode during operation’ state, the control unit can perform the user inquiry command (i.e., “Today weather?”) along with switching to an operation mode from the speech recognition standby mode according to the keyword “LG-XX Hello”.

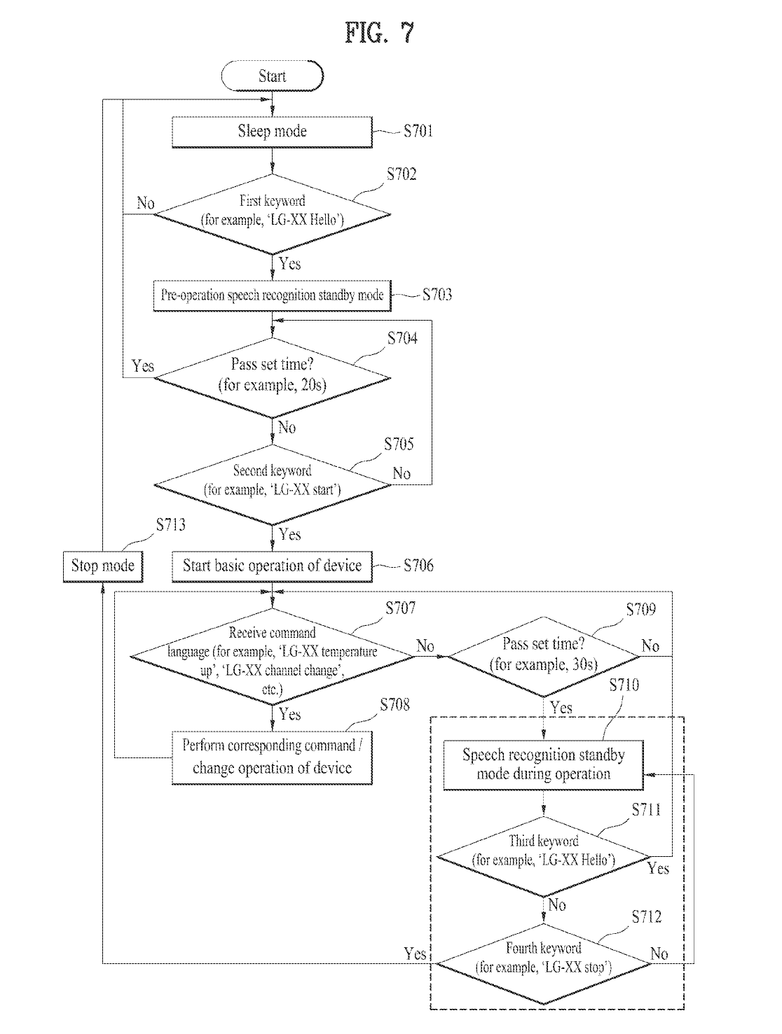

Hereinafter, other embodiments of a method for driving an electric device according to the present invention will be described with reference to FIG. 7 to FIG. 9. The embodiments of FIG. 7 to FIG. 9 illustrate that a ‘stop mode’ for stopping the operation of the electric device is added to the embodiment of FIG. 6, and are especially characterized in relation between the ‘stop mode’ and ‘the speech recognition standby mode during operation’.

FIG. 7 is a flow chart illustrating another example of a method for driving an electric device according to the present invention. It is to be understood that the aforementioned steps S601 to S609 of FIG. 6 are substantially the same as steps S701 to S709 of FIG. 7. In other words, if the first keyword is recognized at the sleep mode state for stopping the operation (S701), the sleep mode state is switched to the pre-operation speech recognition standby mode state S703. Afterwards, if the second keyword is recognized within the predefined time (S704), the control unit 106 performs the basic operation of the electric device (S706). On the other hand, if the second keyword is not recognized within the predefined time, the state (S703) returns to the sleep mode state (S701). If another user command language is recognized at the basic operation state (S706) of the electric device within the predefined time (S709), the control unit 106 performs the corresponding user command, and the basic operation of the electric device is switched to the operation for the corresponding command (S708). On the other hand, if another user command is not recognized at the basic operation state (S706) of the electric device within the predefined time (S709), the state is switched to the speech recognition standby mode state during operation (S710).

In this embodiment, any one of the third keyword (for example, “LG-XX, Hello”) and the third keyword (for example, “LG-XX stop”) may be recognized at the speech recognition standby mode state during operation (S710). For example, if the third keyword (for example, “LG-XX, Hello”) is recognized at the speech recognition standby mode state during operation (S710), the control unit 106 becomes ready for recognizing additional command language for the predefined time (for example, 30 seconds). If the user command language is recognized within the predefined time (S707), the control unit 106 performs the corresponding command (S708). On the other hand, if the user command language is not recognized within the predefined time, the current state returns to the ‘speech recognition standby mode during operation’ state (S710) (S709->S710). In this regard, the ‘speech recognition standby mode during operation’ may mean the state that includes the step S710, the step S711 and the step S712 as shown in a dotted block of FIG. 7.

Also, for example, if the fourth keyword (for example, “LG-XX stop”) is recognized at the speech recognition standby mode during operation state (S710), the control unit 106 stops the operation of the electric device through the stop mode state (S713) and switches the current state to the sleep mode state for stopping the operation (S701). The stop mode state (S713) may be configured as the stop standby mode like the aforementioned embodiments (S313 in FIG. 2 and S508 in FIG. 5) to be switched to the sleep mode state for stopping the operation (S701) only if the fifth keyword (for example, “LG-XX, Hello”) is recognized, in accordance with the design of the product. On the other hand, the stop mode state (S713) may be configured to be switched to the sleep mode state for stopping the operation directly without the stop standby mode after a specific predefined time (for example, one second, five seconds, etc.), in accordance with the design of the product. Also, the stop mode state (S713) may be configured to be switched to the sleep mode for stopping the operation (S701) if the fourth keyword (for example, “LG-XX stop”) is recognized, in accordance with the design of the product.

In this respect, according to the embodiment of FIG. 7, in order to switch the current state to the stop mode state during operation of the device (S713), it is required that the fourth keyword (for example, “LG-XX stop”) should be recognized at the speech recognition standby mode during operation state (S710). In other words, this may prevent the specific electric device from being stopped immediately before the predefined time (for example, 30 seconds) passes after the operation of the electric device is started.

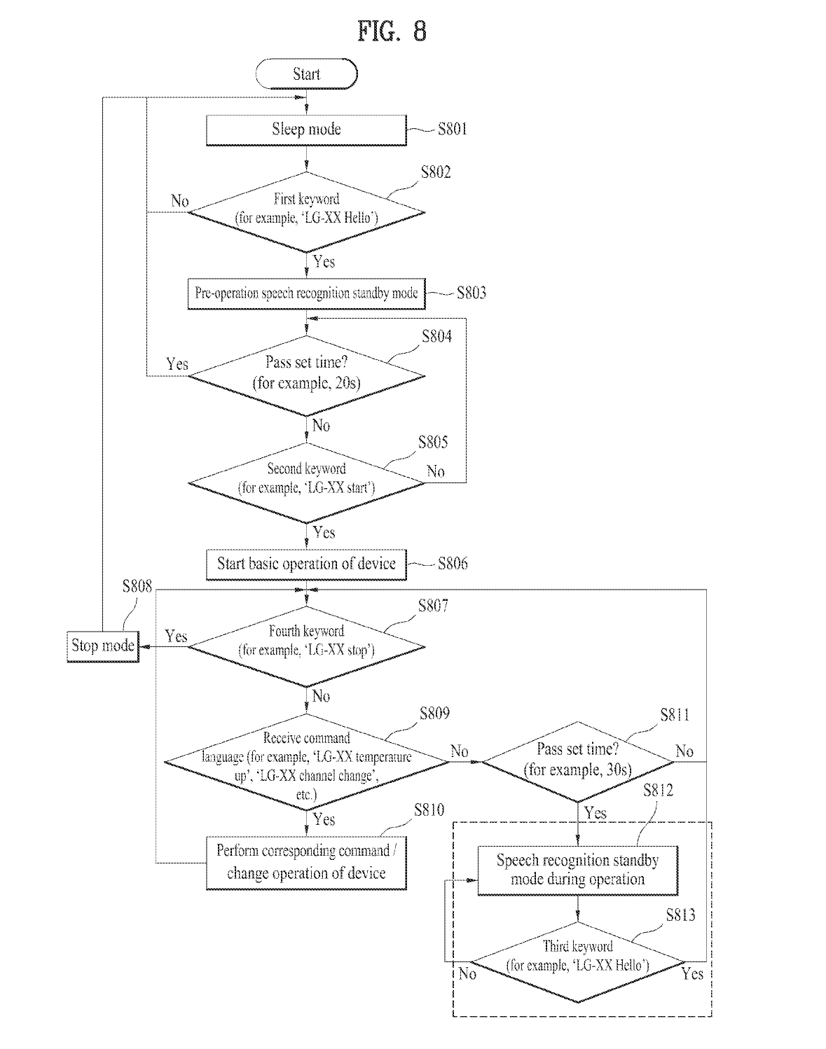

FIG. 8 is a flow chart illustrating still another example of a method for driving an electric device according to the present invention. It is to be understood that the aforementioned steps S601 to S606 of FIG. 6 are substantially the same as steps S801 to S806 of FIG. 8. Also, it is to be understood that the aforementioned steps S607 to S609 of FIG. 6 are substantially the same as steps S809 to S811 of FIG. 8.

In other words, if the first keyword is recognized at the sleep mode state for stopping the operation (S801), the sleep mode state is switched to the pre-operation speech recognition standby mode state S803. Afterwards, if the second keyword is recognized within the predefined time (S804), the control unit 106 performs the basic operation of the electric device (S806). On the other hand, if the second keyword is not recognized within the predefined time, the state (S803) returns to the sleep mode state (S801). If another user command language is recognized at the basic operation state (S806) of the electric device within the predefined time, the control unit 106 performs the corresponding user command, and the basic operation of the electric device is switched to the operation for the corresponding command (S810). On the other hand, if another user command is not recognized at the basic operation state (S806) of the electric device within the predefined time (S811), the state is switched to the ‘speech recognition standby mode during operation’ state (S812).

Also, if the fourth keyword (for example, “LG-XX stop”) for requesting operation stop of the electric device is recognized at the basic operation state (S806) of the electric device or the state for performing a command (S810), that is, during the operation state of the electric device, within the predefined time (S811), the control unit 106 stops the operation of the electric device through the stop mode state (S808) and switches the electric device to the sleep mode state for stopping the operation (S801). The stop mode state (S808) may be configured in various manners in accordance with the design of the product. For example, if the current mode enters the stop mode state (S808) during the operation of the electric device, the stop mode state (S808) may be configured as the stop standby mode like the aforementioned embodiments (S313 in FIG. 2 and S508 in FIG. 5) to be finally switched to the sleep mode state for stopping the operation (S801) only if the fifth keyword (for example, “LG-XX, Hello”) is recognized. On the other hand, if the current mode enters the stop mode state (S808) though the ‘speech recognition standby mode during operation’ state (S812), which will be described later, the current mode state may be configured to be switched to the sleep mode state (S801) for stopping the operation, without the stop standby mode, that is, even though the fifth keyword (for example, “LG-XX, Hello”) is not recognized.

Accordingly, in this embodiment, the third keyword (for example, “LG-XX, Hello”) is only recognized at the ‘speech recognition standby mode during operation’ state (S812). For example, if the third keyword (for example, “LG-XX, Hello”) is recognized at the ‘speech recognition standby mode during operation’ state (S812), the control unit 106 becomes ready for recognizing additional command language for the predefined time (for example, 30 seconds). If the fourth keyword (for example, “LG-XX stop”) is recognized within the predefined time (S807), the electric device enters the stop mode state (S808). If the user command language is recognized within the predefined time (S809), the control unit 106 performs the corresponding command (S810). On the other hand, if none of the fourth keyword (for example, “LG-XX stop”) and the user command language is not recognized within the predefined time, the current state returns to the ‘speech recognition standby mode during operation’ state (S812) (S811->S812). In this regard, the ‘speech recognition standby mode during operation’ may mean the state that includes the step S812 and the step 813, as shown in a dotted block of FIG. 8.

According to the embodiment of FIG. 8, in order to switch the speech recognition standby mode state (S812) to the stop mode state (S808), the third keyword (for example, “LG-XX, Hello”) should first be recognized. Then, it is required that the fourth keyword (for example, “LG-XX stop”) should be recognized.

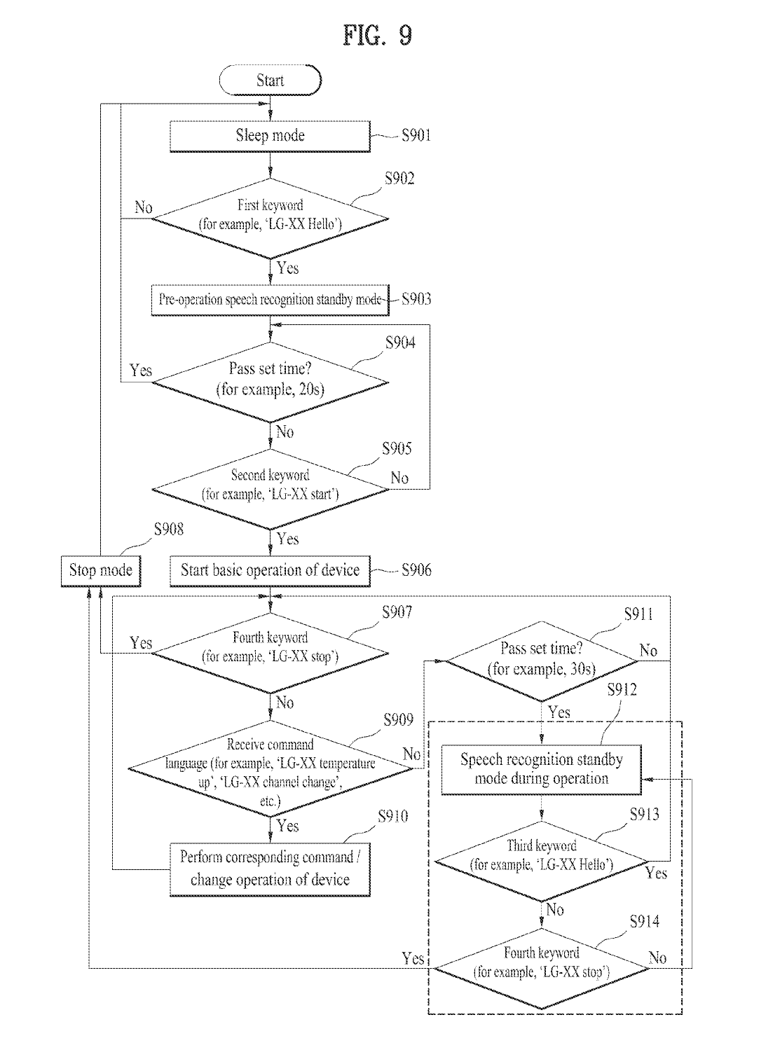

FIG. 9 is a flow chart illustrating still another example of a method for driving an electric device according to the present invention. It is to be understood that the aforementioned steps S601 to S606 of FIG. 6 are substantially the same as steps S901 to S906 of FIG. 9. Also, it is to be understood that the aforementioned steps S607 to S609 of FIG. 6 are substantially the same as steps S909 to S911 of FIG. 9.

In other words, if the first keyword is recognized at the sleep mode state for stopping the operation (S901), the sleep mode state is switched to the pre-operation speech recognition standby mode state S903. Afterwards, if the second keyword is recognized within the predefined time (S904), the control unit 106 performs the basic operation of the electric device (S906). On the other hand, if the second keyword is not recognized within the predefined time, the state (S903) returns to the sleep mode state (S901). If another user command language is recognized at the basic operation state (S906) of the electric device within the predefined time (S911), the control unit 106 performs the corresponding user command, and the basic operation of the electric device is switched to the operation for the corresponding command (S910). On the other hand, if another user command is not recognized at the basic operation state (S906) of the electric device within the predefined time (S911), the state is switched to the ‘speech recognition standby mode during operation’ state (S912).

Also, if the fourth keyword (for example, “LG-XX stop”) for requesting operation stop of the electric device at the operation states (S906 and S910) of the electric device within the predefined time (S911), the control unit 106 stops the operation of the electric device through the stop mode state (S908) and switches the electric device to the sleep mode state for stopping the operation (S901). The stop mode state (S908) may be configured in various manners in accordance with the design of the product. For example, if the current mode enters the stop mode state (S908) during the operation of the electric device, the stop mode state (S908) may be configured as the stop standby mode like the aforementioned embodiments (S313 in FIG. 2 and S508 in FIG. 5) to be finally switched to the sleep mode state for stopping the operation (S901) only if the fifth keyword (for example, “LG-XX, Hello”) is recognized. Also, if the ‘speech recognition standby mode during operation’ state (S912), which will be described later, is directly switched to the stop mode state (S908), the current mode state may be configured as the aforementioned stop standby mode to be finally switched to the sleep mode state (S901) for stopping the operation only if the fifth keyword (for example, “LG-XX, Hello”) is recognized.

Accordingly, any one of the third keyword (for example, “LG-XX, Hello”) and the fourth keyword (for example, “LG-XX stop”) may be recognized at the ‘speech recognition standby mode during operation’ state (S912) (S913 and S914). For example, if the third keyword (for example, “LG-XX, Hello”) is recognized at the ‘speech recognition standby mode during operation’ state (S912), the control unit 106 becomes ready for recognizing additional command language for the predefined time (for example, 30 seconds). If the user command language or the fourth keyword is recognized within the predefined time (S907 and S908), the control unit 106 performs the corresponding command (S910). On the other hand, if the user command language or the fourth keyword is not recognized within the predefined time, the current state returns to the ‘speech recognition standby mode during operation’ state (S912) (S911->S912). In this regard, the ‘speech recognition standby mode during operation’ may mean the state that includes the step S912, the step S913 and the step 914, as shown in a dotted block of FIG. 9.

Also, for example, if the fourth keyword (for example, “LG-XX stop”) is recognized at the ‘speech recognition standby mode during operation’ state (S912) (S914), the control unit 106 stops the operation of the electric device through the stop mode state (S908) and switches the electric device to the sleep mode state for stopping the operation (S901).

In this respect, according to the embodiment of FIG. 9, in order to switch the current state to the stop mode state (S908), the fourth keyword (for example, “LG-XX stop”) may be recognized during operation of the electric device, or at the ‘speech recognition standby mode during operation’ state (S912). Accordingly, according to this embodiment, it is advantageous in that the user may conveniently perform the stop mode for stopping the electric device at any time.

In the meantime, according to the present invention, the microphone may be installed in the electric device as the speech receiving unit 103 to receive the speech of the user. Hereinafter, the embodiments related to the position of the microphone installed in the air conditioner will be described.

According to one embodiment of the present invention, two or more microphones are installed in the stand type air conditioner, and one or more microphones are installed in the wall-mounted type air conditioner or the ceiling type air conditioner.

FIG. 10a to FIG. 10g are diagrams illustrating various embodiments of positions of two microphones provided in a stand type air conditioner according to the present invention. In particular, the present invention is characterized in that two microphones are arranged in the air conditioner so that the microphones may be less affected by the wind during operation of the air conditioner.

FIG. 10a illustrates an example that two microphones 601 and 602 are installed at the center of the front of the air conditioner according to the present invention at a certain distance from each other.

FIG. 10b illustrates an example that two microphones 601 and 602 are installed at the right side of the center of the front of the air conditioner according to the present invention. For example, if a button panel (or key input unit) is located at the right side of the center of the front of the air conditioner, two microphones may be installed below the button panel at a certain distance from each other.

FIG. 10c illustrates an example that two microphones 601 and 602 are installed at the center below the front of the air conditioner according to the present invention at a certain distance from each other.

FIG. 10d illustrates an example that two microphones 601 and 602 are installed at both sides of the center of the front of the air conditioner according to the present invention.

FIG. 10e illustrates an example that two microphones 601 and 602 are installed above the front of the air conditioner according to the present invention at a certain distance from each other.

FIG. 10f illustrates an example that two microphones 601 and 602 are installed at both sides of the rear of the air conditioner according to the present invention at a certain distance from each other.

FIG. 10g illustrates an example that two microphones 601 and 602 are installed at a lateral portion of both sides of the center of the front of the air conditioner according to the present invention.

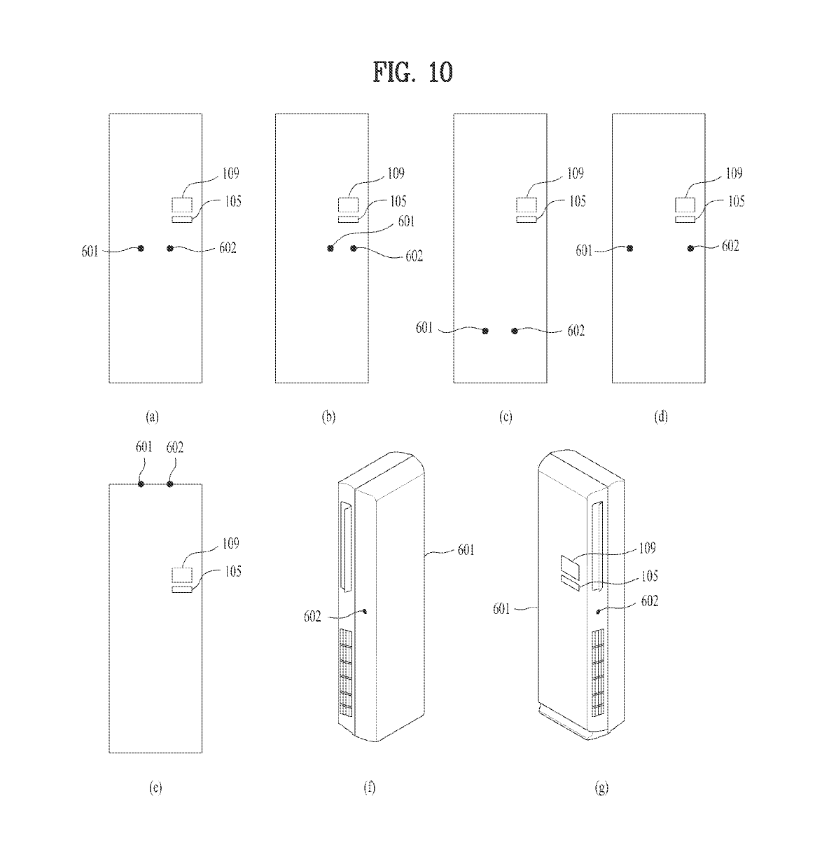

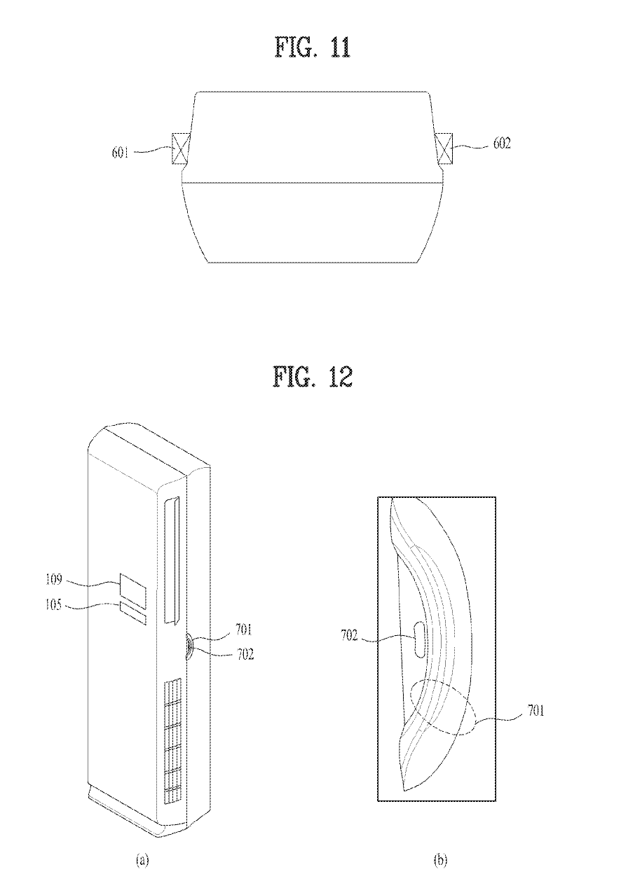

FIG. 11 is a diagram illustrating an example of positions of two microphones viewed from the top of an air conditioner when the two microphones are provided as shown in (g) of FIG. 10.

At this time, the distance between the two microphones 601 and 602 is determined in accordance with the positions of the two microphones installed in the air conditioner. For example, if the two microphones 601 and 602 are installed as shown in (a), (b), (c) and (e) of FIG. 10, they are spaced apart from each other at 10 cm or more. For another example, if the two microphones 601 and 602 are installed as shown in (d), (f) and (g) of FIG. 10, they are spaced apart from each other at an interval the same as or similar to a width of the air conditioner.

Also, if the two microphones 601 and 602 are installed at the front of the air conditioner as shown in (a), (b), (c), (d) and (e) of FIG. 10, it is advantageous in that the speech of the user is likely to be directly absorbed in the microphones and the user may intuitively identify the positions of the microphones. If the two microphones 601 and 602 are installed at a rear side of the air conditioner or lateral portions of both sides of the front of the air conditioner as shown in (f) and (g) of FIG. 10, it is advantageous in that appearance of the air conditioner becomes better in view of design as the microphones are not viewed in front of the air conditioner. Also, in this case, it is advantageous for the case where it is difficult to install the microphones due to a material used for appearance of the air conditioner.

Also, if strength of the wind of the air conditioner becomes strong, the wind enters the microphones installed in the air conditioner, whereby a problem may occur in that a recognition rate of a speech command language may be reduced when the user utters the speech command language. According to one embodiment of the present invention, in order to solve the problem, the microphones are installed such that the microphones are less affected by the wind of the air conditioner.

To this end, a microphone housing unit that includes a projection member 701 and a microphone mounted in the projection member 701 as shown in (a) of FIG. 12 is respectively installed at lateral portions of both sides of the center of the front of the air conditioner as shown in (g) of FIG. 10 or FIG. 11.

FIG. 12b is a detailed diagram illustrating a projection member 701 of FIG. 12(a). According to one embodiment of the present invention, the projection member 701 is curved in an up and down direction, so that the speech of the user is collected in the microphones and the wind discharged from the top to the bottom of the air conditioner body does not enter the microphones.

At this time, the microphone according to one embodiment of the present invention may be connected with the projection member through a connection hole after being installed in the air conditioner body. According to another embodiment of the present invention, the microphone may directly be installed inside the projection member.

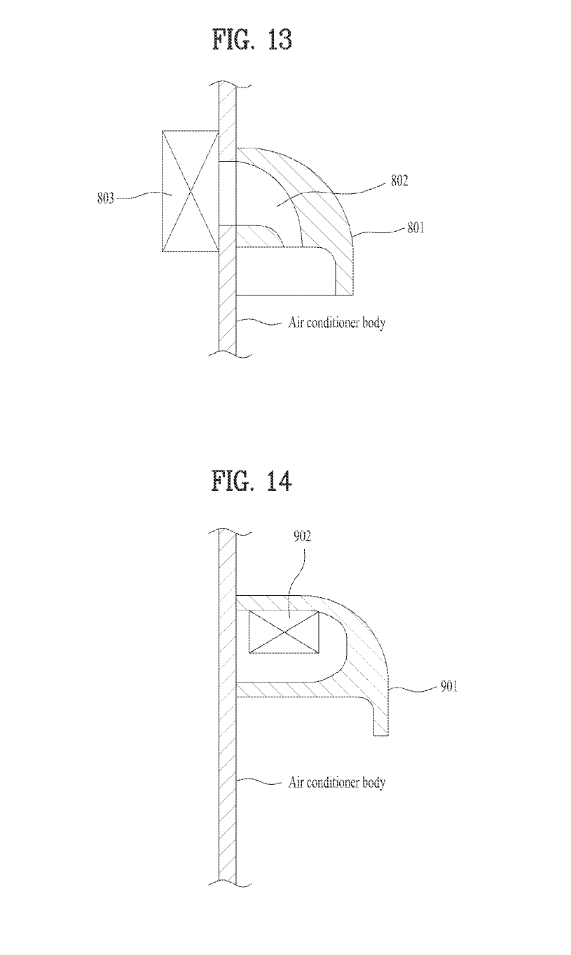

FIG. 13 illustrates an example that the microphone according to the present invention is installed at an inner side of the air conditioner body. At this time, a projection member 801 is fixed to an outer side of the air conditioner body in a concave shape towards the front of the air conditioner as shown in (b) of FIG. 12. A connection hole 802 which is connected with the microphone 803 is formed at the front of the projection member 801. In other words, the speech of the user, which is collected in the projection member 801, enters the microphone 803 through the connection hole 802. In case of FIG. 13, the microphone 803 is installed to be recessed as much as 5.5 mm from the side of the air conditioner body.

FIG. 14 illustrates an example that the microphone according to the present invention is directly installed inside the projection member. At this time, a projection member 901 is fixed to an outer side of the air conditioner body in a concave shape towards the front of the air conditioner as shown in (b) of FIG. 12, and a microphone 902 is installed at the front of the projection member 901. In other words, the microphone 902 is installed at the outer side of the air conditioner body.

Also, according to one embodiment of the present invention, a microphone housing unit having the structure of FIG. 13 or FIG. 14 is located below a wind outlet of the air conditioner. At this time, if the microphone is located to be far away from the wind outlet, the better signal to nose ratio is obtained. The microphone housing unit according to the present invention is located to be far away from the wind outlet as much as 30 cm, approximately in accordance with one embodiment. If the microphone housing unit is located towards the bottom of the air conditioner, it may be covered with a sofa or other furniture, and noise such as sound of a footstep may easily enter the microphone. Accordingly, according to one embodiment of the present invention, the microphone housing unit is installed to be higher than the bottom as much as 20 cm, approximately.

According to the present invention, two microphone housing units that include the projection member and microphone are respectively installed at lateral portions of both sides of the center of the front of the air conditioner, whereby the microphone housing units may be less affected by the wind. As a result, the present invention may provide a high speech recognition function even though the user utters the speech command at a remote distance such as 3 m and 5 m during the operation of the air conditioner.

The stand type air conditioner has been described as above. However, according to the present invention, the microphone housing unit that includes a projection member and a microphone may be installed in the wall-mount type air conditioner or the ceiling type air conditioner, whereby the aforementioned advantages of the present invention may be obtained.

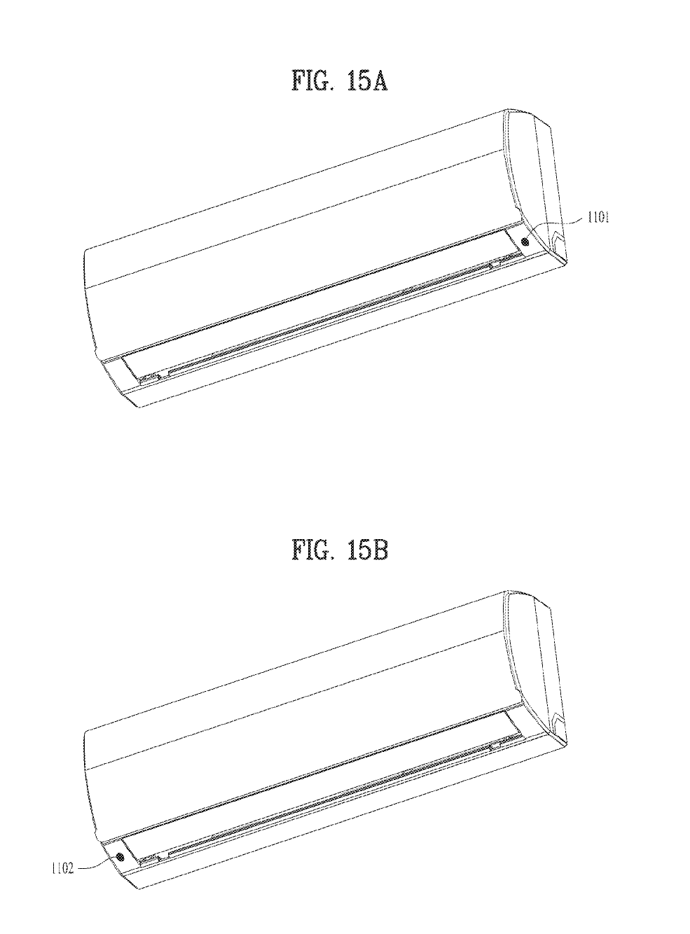

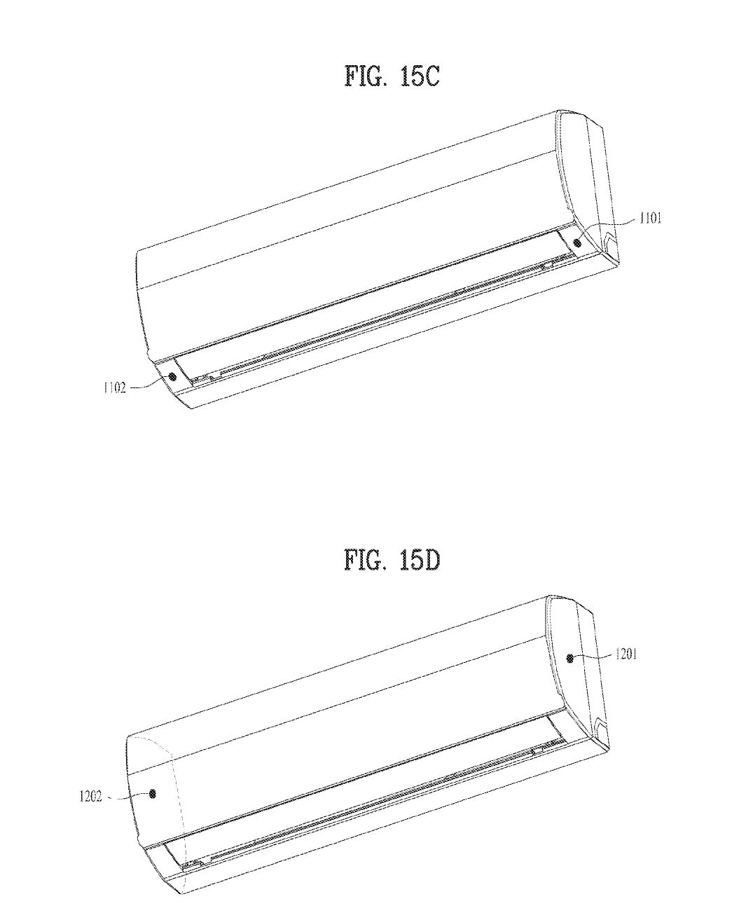

FIG. 15a to FIG. 15d are diagrams illustrating various embodiments of a position of a microphone provided in a wall-mounted type air conditioner according to the present invention. In particular, the present invention is characterized in that the microphone is arranged, whereby the microphone may be less affected by the wind during the operation of the air conditioner.

FIG. 15a illustrates an example that one microphone 1101 is installed below the right side on the bottom of the air conditioner body.

FIG. 15b illustrates an example that one microphone 1102 is installed below the left side on the bottom of the air conditioner body.

FIG. 15c illustrates an example that two microphones 1101 and 1102 are respectively installed below the right side and the left side on the bottom of the air conditioner body.

FIG. 15d illustrates an example that two microphones 1201 and 1202 are respectively installed at lateral portions of both sides of the center of the front of the air conditioner according to the present invention.

In FIG. 15a to FIG. 15d, each microphone is mounted inside a corresponding projection member. At this time, the microphone may be connected with the corresponding projection member through a connection hole after being installed inside the air conditioner body, or may directly be installed inside the projection member. In case of the latter case, the microphone is installed at the outer side of the air conditioner body.

In FIG. 15a to FIG. 15d, according to one embodiment of the present invention, the projection member is curved in a left and right direction or up and down direction, so that the speech of the user is collected in the microphones and the wind discharged from the air conditioner body does not enter the microphones.

According to another embodiment of the present invention, the microphone housing unit that includes a projection member and a microphone may be installed in the ceiling type air conditioner. Also, the microphone housing unit is installed in at least one of four sides of the ceiling type air conditioner. At this time, since the position of the microphone housing unit installed in the ceiling type air conditioner and the shape of the projection member may be applied from the stand type air conditioner or the wall-mounted type air conditioner easily by the person with ordinary skill in the art, their detailed description will be omitted.

The apparatus and method for driving the air conditioner has been described in detail as above. It will be apparent that the aforementioned apparatus and method for driving the air conditioner according to the present invention may be applied to other electric devices.

It will be apparent to those skilled in the art that the present invention can be embodied in other specific forms without departing from the spirit and essential characteristics of the specification. Thus, the above embodiments are to be considered in all respects as illustrative and not restrictive. The scope of the specification should be determined by reasonable interpretation of the appended claims and all change which comes within the equivalent scope of the specification are included in the scope of the specification.

What is claimed is:

1. A method for driving an electric device using speech recognition, the method comprising the steps of:
switching to a pre-operation speech recognition standby mode if a first keyword is recognized during an operation stop state;
starting basic operation of the device if a second keyword is recognized during the pre-operation speech recognition standby mode; and
performing a corresponding command if at least one of a plurality of commands is recognized as a user command within a predefined time during the basic operation,
wherein the first keyword, the second keyword and the plurality of commands are different from one another.

2. The method according to claim 1, further comprising the step of switching to a speech recognition standby mode during operation if a user command is not recognized within a predefined time during the basic operation, wherein a third keyword is required to be first recognized to recognize the user command at the speech recognition standby mode during operation.

3. The method according to claim 2, wherein the third keyword is the same as the first keyword.

4. The method according to claim 2, wherein the user command includes a fourth keyword for switching to a stop mode.

5. The method according to claim 1, further comprising the steps of switching to a speech recognition standby mode during operation if a user command is not recognized within the predefined time during the basic operation, and switching the speech recognition standby mode during operation to the stop mode if a fourth keyword is recognized at the speech recognition standby mode during operation.

6. The method according to claim 1, further comprising the steps of switching to a speech recognition standby mode during operation if a user command is not recognized within the predefined time during the basic operation, and recognizing either a third keyword or a fourth keyword at the speech recognition standby mode during operation and switching to a state that may recognize another user command if the third keyword is recognized and switching to a stop mode state if the fourth key word is recognized.

7. The method according to claim 6, further comprising the step of recognizing a fifth keyword to switch the stop mode state to the operation stop state.

8. An apparatus for driving an electric device using speech recognition, the apparatus comprising:
a speech receiving unit configured to receive a speech;
a speech recognition unit configured to recognize a previously set keyword and a user command from the received speech; and
a control unit configured to control an operation of the electric device by using the speech recognized result,
wherein the control unit controls the operation of the electric device by
switching to a pre-operation speech recognition standby mode if a first keyword is recognized during an operation stop state,
starting basic operation of the device if a second keyword is recognized during the pre-operation speech recognition standby mode, and
performing a corresponding command if at least one of a plurality of commands is recognized as a user command within a predefined time during the basic operation,
wherein the first keyword, the second keyword and the plurality of command languages being different from one another.

9. The apparatus according to claim 8, wherein the control unit switches to a speech recognition standby mode during operation if a user command is not recognized within a predefined time during the basic operation, and a third keyword should is required to be first recognized to recognize the user command at the speech recognition standby mode during operation.

10. The apparatus according to claim 9, wherein the third keyword is the same as the first keyword.

11. The apparatus according to claim 9, wherein the user command includes a fourth keyword for switching to a stop mode.

12. The apparatus according to claim 8, wherein the control unit switches to a speech recognition standby mode during operation if a user command is not recognized within the predefined time during the basic operation, and switches the speech recognition standby mode during operation to a stop mode if a fourth keyword is recognized at the speech recognition standby mode during operation.

13. The apparatus according to claim 8, wherein the control unit switches to a speech recognition standby mode during operation if a user command is not recognized within the predefined time during the basic operation, and recognizes either a third keyword or a fourth keyword at the speech recognition standby mode during operation and switches to a state that may recognize another user command if the third keyword is recognized and switches to a stop mode state if the fourth key word is recognized.

14. The apparatus according to claim 13, wherein the control unit recognizes a fifth keyword to switch the stop mode state to the operation stop state.

15. The apparatus according to claim 8, further comprising a driving unit configured to receive a control signal of the control unit, which is intended to control the operation of the device, and to switch to a corresponding mode or perform a corresponding command operation.

16. The apparatus according to claim 8, wherein the speech receiving unit includes a microphone housing unit that includes a projection member and a microphone, the microphone being installed at an inner side of an air conditioner and the projection member being fixed to an outer side of the air condition in a concave shape towards a front side, and a connection hole connected with the microphone is further provided at the front side.

17. The apparatus according to claim 16, wherein the microphone housing unit includes two microphones that are respectively installed at lateral portions of both sides of the center of the front of the electric device.

18. The apparatus according to claim 16, wherein the projection member is curved in an up and down direction so that the wind discharged from the top of the electric device to the bottom of the electric device does not enter the microphone.

19. The apparatus according to claim 8, wherein the speech receiving unit includes a microphone housing unit that includes a projection member and a microphone, the projection member being fixed to an outer side of the electric device in a concave shape towards a front side, and the microphone being installed inside the projection member.

20. A method for driving an electric device using speech recognition, the method comprising the steps of:
switching to a speech recognition standby mode if a user command is not recognized within a predefined time during the driving the electric device;
switching to an operation mode from the speech recognition standby mode if a predefined keyword is recognized at the speech recognition standby mode; and
performing a user command if the user command is recognized during the operation mode,
wherein the user command includes one of an operation command and an inquiry command.
